(19) United States
(12) Patent Application Publication
(10) Pub. No.: US 2010/0223184 A1
(43) Pub. Date: Sep. 2, 2010

(54) Sponsored Accounts For Computer-Implemented Payment System

(75) Inventor: Jeffrey William Perlman, Gordon (AU)

Correspondence Address: JONES DAY, 222 EAST 41ST ST, NEW YORK, NY, 10017, US

(73) Assignee: Visa International Service Association, Foster City, CA (US)

(21) Appl. No.: 12/778,479

(22) Filed: May 12, 2010

Related U.S. Application Data
(63) Continuation-in-part of application No. 11/870,799, filed on Oct. 11, 2007.
(60) Provisional application No. 61/256,136, filed on Oct. 29, 2009.
(60) Provisional application No. 60/829,057, filed on Oct. 11, 2006.

(51) Int. Cl. G06Q 40/00; G06Q 20/00

(52) U.S. Cl. 705/44; 705/39

(57) ABSTRACT

Systems and methods for primary and sponsored accounts are provided. A system may include an account processor to execute software instructions for creating and managing electronic payment accounts and an accounts database to store account data from the account processor. The account processor may be configured to create a primary account and a sponsored account in the accounts database. The primary account may be associated with a primary account holder who has access to the primary account to add and remove funds. The sponsored account may be associated with both the primary account holder and a sponsored account holder, where the primary account holder has access to the sponsored account to transfer funds between the primary account and the sponsored account in order to add and remove funds from the sponsored account, and the sponsored account holder has access to the sponsored account for making transactions using funds in the sponsored account.

### CROSS-REFERENCE TO RELATED APPLICATIONS

This application is a continuation-in-part of U.S. patent application Ser. No. 11/870,799, titled “Method and System for Processing Micropayment Transactions,” filed on Oct. 11, 2007, which claims priority from U.S. Provisional Patent Application No. 60/829,057, filed on Oct. 11, 2006. This application also claims priority from U.S. Provisional Patent Application No. 61/256,136, titled “Sponsored Accounts for Computer-Implemented Payment Systems,” filed on Oct. 29, 2009. The entirety of these priority applications are incorporated herein by reference.

### TECHNICAL FIELD

The present disclosure relates generally to computer-implemented systems and methods for making electronic payments.

### BACKGROUND

Electronic commerce, commonly known as electronic marketing, e-commerce, or eCommerce, consists of the buying and selling of products or services over electronic systems such as the Internet and other computer networks. The amount of trade conducted electronically has grown extraordinarily with widespread Internet usage. Commerce conducted in this manner utilizes a complex web of innovations in electronic funds transfer, supply chain management, Internet marketing, online transaction processing, electronic data interchange (EDI), inventory management systems, automated data collection systems, and many others. Modern electronic commerce typically uses the World Wide Web at least at some point in the transaction's lifecycle, although it can encompass a wider range of technologies such as e-mail as well.

A large percentage of electronic commerce is conducted entirely electronically for virtual items such as access to premium content on a website. Additionally, much electronic commerce involves the transportation of physical items in some way. Online retailers are sometimes known as e-tailers and online retail is sometimes known as e-tail. Almost all big retailers have electronic commerce presence on the World Wide Web.

With the continued increase in competition on the web, product, content, and service providers must strive to not only produce the best products, content, and services, but they must also compete to offer the most intuitive and fast mechanisms for providing their wares to interested consumers.

Minors and other users that do not have access to credit cards, electronic checking accounts, or other external funding sources that can be accessed electronically for issuing payments to other parties currently have no convenient way of purchasing items for which e-commerce merchants require electronic payments. Such users are restricted by legal age requirements for having access to accounts, or they may be unable or unwilling to obtain credit accounts for numerous reasons. While a second person may make purchases for such users, this solution is not ideal. It requires significant interaction by the second person, and also prevents users from having a measure of autonomy. For example, a parent or an employer may want to provide funds for a child or employee and provide some autonomy for the child or employee, but the parent or employer may also want to exercise various levels of control over how much money is spent and from what merchants. They may also want to monitor the purchases that have been made.

### SUMMARY

Systems and methods for primary and sponsored accounts are provided. A system may include an account processor to execute software instructions for creating and managing electronic payment accounts and an accounts database to store account data from the account processor. The account processor may be configured to create a primary account and a sponsored account in the accounts database. The primary account may be associated with a primary account holder who has access to the primary account to add and remove funds. The sponsored account may be associated with both the primary account holder and a sponsored account holder, where the primary account holder has access to the sponsored account to transfer funds between the primary account and the sponsored account in order to add and remove funds from the sponsored account, and the sponsored account holder has access to the sponsored account for making transactions using funds in the sponsored account.

A method of creating an electronic payment account may include the steps of: receiving at an account processor a request to create a new electronic payment account, the request including account profile information relating to an applicant; and determining from the account profile information if the applicant is over a predetermined minimum age for opening a primary account. If the applicant is over the predetermined minimum age, then a primary account may be opened for the applicant using the account profile information. If the applicant is not over the predetermined minimum age, then the account processor may: automatically direct the applicant to a graphical user interface for requesting a sponsored account; receive via the graphical user interface information identifying a sponsor; request approval for the sponsored account from the sponsor; and upon receiving approval from the sponsor, create a sponsored account for the applicant and linking the sponsored account to a primary account associated with the sponsor, wherein the sponsor is given access to the sponsored account to transfer funds from the primary account to the sponsored account and the applicant is given access to the sponsored account for making purchases using funds in the sponsored account.

The details of one or more embodiments of the invention are set forth in the accompanying drawings and the description below. Other features, aspects, and advantages of the invention will become apparent from the description, the drawings, and the claims.

### BRIEF DESCRIPTION OF THE DRAWINGS

FIG. 1 depicts a dataflow diagram for exemplary participants in a micropayment transaction.

FIG. 2 depicts a flow diagram for an exemplary process of processing a micropayment transaction.

FIG. 3 depicts a flow diagram for an exemplary settlement process for a micropayment processing system.

FIGS. 4A1, 4A2 and 4B depict a flow diagram for an exemplary micropayment purchase from a payee website.

FIG. 5 shows a block diagram of an example electronic payment system.

FIG. 6 shows a block diagram of an example primary and sponsored account system.

FIG. 7 shows an example flow chart depicting a method to setup a sponsored account.

FIG. 8 shows a second example flow chart depicting a method to setup a sponsored account.

FIG. 8A shows an example of a graphical user interface for providing information for opening a sponsored account.

FIG. 8B shows an example of a notification transmitted to an identified user for completing a sponsored account registration.

FIG. 9 shows an example graphical user interface for entering an e-mail address.

FIG. 10 shows an example graphical user interface for selecting to sign-in or create an account.

FIG. 11 shows an example graphical user interface webpage for a sponsored account.

FIG. 12 shows a portion of an example graphical user interface webpage for a primary account.

FIG. 13 shows an example graphical user interface for a Sponsored Account Summary webpage.

FIG. 14 shows an example graphical user interface for displaying trusted level 2 sellers associated with a sponsored account.

FIG. 15 shows an example of a graphical user interface for the View Details of the sponsored account webpage.

FIG. 16 shows an example graphical user interface page for topping up sponsored accounts.

FIG. 17 shows an example graphical user interface showing the confirmation message for the transferred funds.

FIG. 18 shows an example graphical user interface page for scheduling periodic top-ups to the sponsored accounts.

FIG. 19 illustrates an example graphical user interface for selecting which funding source to use for the periodic top-up.

FIGS. 20A and 20B show an example graphical user interface page for editing the periodic top-up.

FIG. 21 shows an example graphical user interface page for transferring money from sponsored accounts.

FIG. 22 shows an example notification explaining that the user has insufficient funds.

FIG. 23 shows an example graphical user interface page for closing a sponsored account.

FIG. 24 shows an example graphical user interface for confirming an account closure.

FIGS. 25A and 25B show an example graphical user interface for viewing the read-only information of a sponsored account and for reopening the account.

FIG. 26 shows an example graphical user interface for closing the account from the sponsored account.

FIG. 27 shows an example notification to the sponsor about the sponsored account closure.

FIG. 28 shows an example e-mail notification to the sponsor about the sponsored account closure.

FIG. 29 shows an example of a notification that a sponsored account has been reactivated.

FIG. 30 shows an example notification to the sponsored account holder that a sponsored account has been reactivated.

FIGS. 31-47 illustrate another example method and example user interfaces for opening a sponsored account.

FIG. 48 illustrates exemplary hardware on which the various embodiments of the sponsored account system may be practiced.

### DETAILED DESCRIPTION

A payer is an entity that engages in a value transfer, such as an individual or a small business. The payer participates in a transaction with a payee, usually by purchasing a good or service from the payee and/or by exchanging items, services or other value with the payee.

A payee is a second entity that engages in a value transfer. A payee participates in a transaction with a payer, usually by providing a good or service to the payer in exchange for value and/or by exchanging items, services or other value with the payer.

A transaction is a flow of value between entities, such as a payer and a payee.

A micropayment transaction is a transaction in which the value to be transferred is less than a threshold value, such as, for example and without limitation, approximately five dollars.

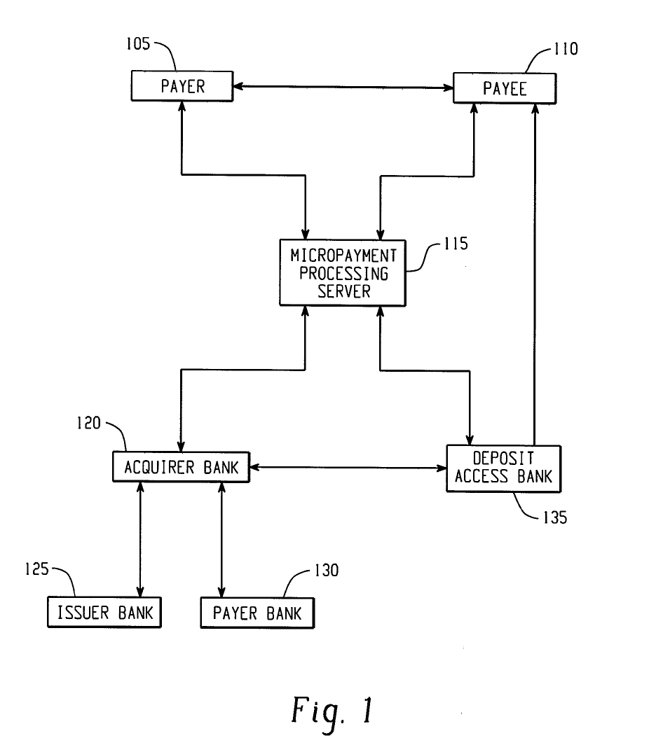

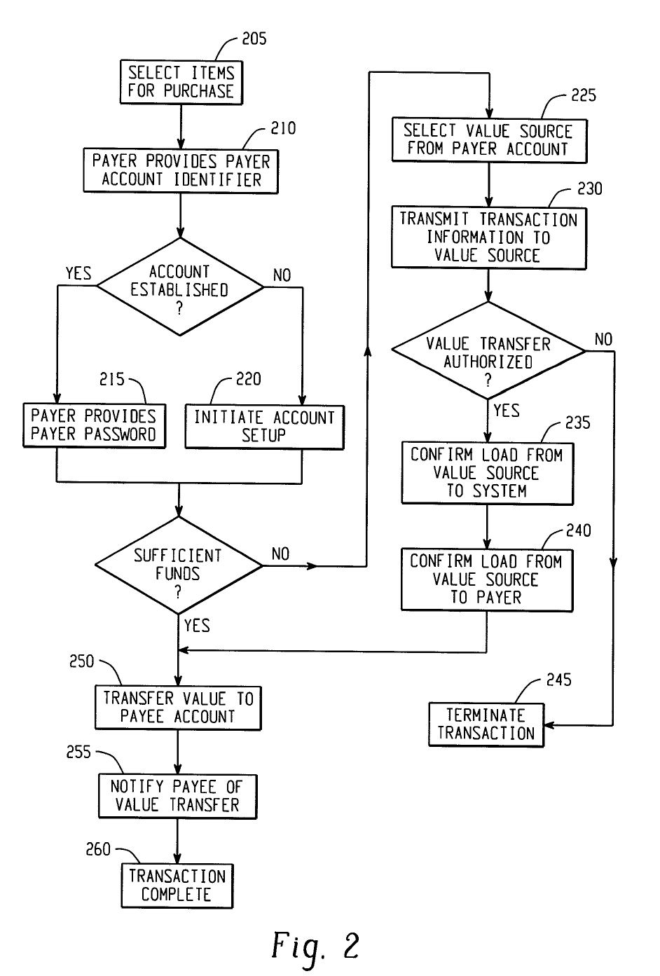

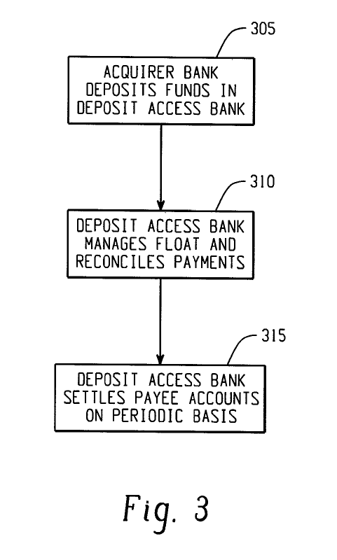

FIG. 1 depicts a dataflow diagram for exemplary participants in a micropayment transaction according to an embodiment. As shown in FIG. 1, the micropayment transaction processing system may include a payer 105, a payee 110, a micropayment processing server 115, an acquirer bank 120, an issuer bank 125, a payer bank 130, and a deposit access bank 135 to manage the float of value in the system. Exemplary communications between two parties are depicted by the lines in FIG. 1 and are described in more detail below in reference to FIGS. 2 and 3. Communicating parties may communicate with each other via, for example, the Internet, and intranet and/or any other data network. Other communication methods, such as a telephone, a PDA, a Blackberry, a gaming console, an interactive kiosk and the like may also be used within the scope of the present disclosure.

FIG. 2 depicts a flow diagram for an exemplary process of processing a micropayment according to an embodiment. As shown in FIG. 2, a payer 105 may shop at an online payee 110 and, for example, select 205 one or more goods and/or services for purchase from the payee. If the transaction is a micropayment transaction, a list of selectable payment methods may include an icon for a micropayment processing system 115. The payer 105 may select the micropayment processing system 115. The payer may initiate processing of the micropayment transaction by submitting 210 an identifier, such as, for example and without limitation, an email address, a “user ID,” a telephone number and/or any portion thereof. In an embodiment, a “cookie” or other persistent data located on the payer's network access device may relate to such an identifier. If the payer 105 has already established an account with the payment processing system 115, the payer 105 may be directed to the system (or to a location within the payee's website 110 designed to receive information on behalf of the micropayment processing system) to provide 215 a password to authorize payment to the payee. Other authentication methods, such as, without limitation, biometric devices or cryptographic tokens, may be used to authenticate the payer to the micropayment processing system. If the payer has not already established an account with the micropayment processing system 115, the payer 105 may be directed to a registration sub-system in order to initiate 220 an account setup routine.

Upon completion of the account setup routine or once the password is entered or the payer is otherwise authenticated to the micropayment processing system if an account had previously been established, a determination may be made as to whether sufficient value is present to complete the transaction. If not, the payer 105 may select a value source from which funds are received 225 by the micropayment processing system 115. In an embodiment, funds may be received 225 from, for example and without limitation, credit card, debit card, a direct debit from a bank account via, for example, Automated Clearing House (ACH), direct deposit or the like, over the counter to an agent, and/or from a deposited amount. The micropayment processing system 115 may transmit 230 the transaction information supplied by the payer 105 to the acquirer bank 120. The acquirer bank 120 may facilitate an authorization procedure with a direct debit account or the card acquirer. If the payer 105 is authorized, the acquirer bank 120 may confirm 235 the load of value to the micropayment processing system 115, which forwards 240 the confirmation to the payer. Otherwise, the micropayment process may terminate 245. In an alternate embodiment, the payer 105 may be provided with one or more additional opportunities to provide proper authorizing information to the micropayment processing system 115.

Once sufficient value is present to complete the transaction, the micropayment processing system 115 may transfer 250 funds from any payer account to any payee account. In an embodiment, a payer account and a payee account may be attributes of the same account. The micropayment processing system 115 may then notify 255 the payer 105 and the payee 110 that the transaction has successfully completed. The payer 105 may then be returned 260 to the payee website 110.

FIG. 3 depicts a flow diagram for an exemplary settlement process for a micropayment processing system according to an embodiment. As shown in FIG. 3, the acquirer bank 120 may deposit 305 funds into an account operated by the deposit access bank 135. The deposit access bank 135 may manage the float (float occurs when an account in the system retains a positive balance of funds) and reconcile 310 payments for the micropayment processing system 115. The deposit access bank 135 may settle 315 its account with each payee on, for example, a periodic basis. For example, the deposit access bank 135 may settle 315 its account with each payee on an hourly, daily, weekly or monthly basis. Other settlement periods may also be used within the scope of this disclosure.

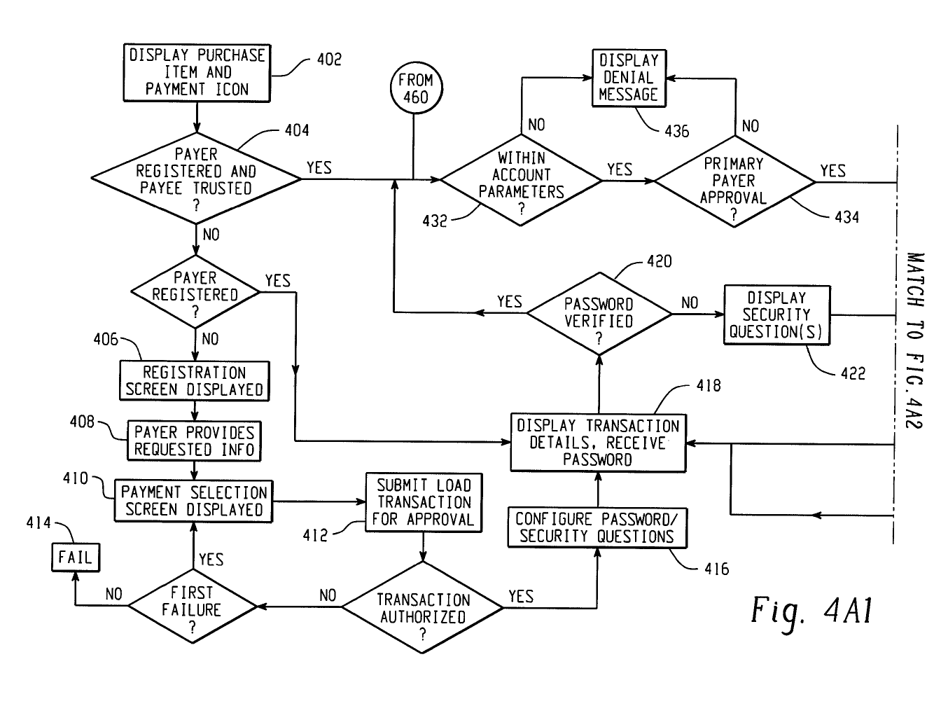

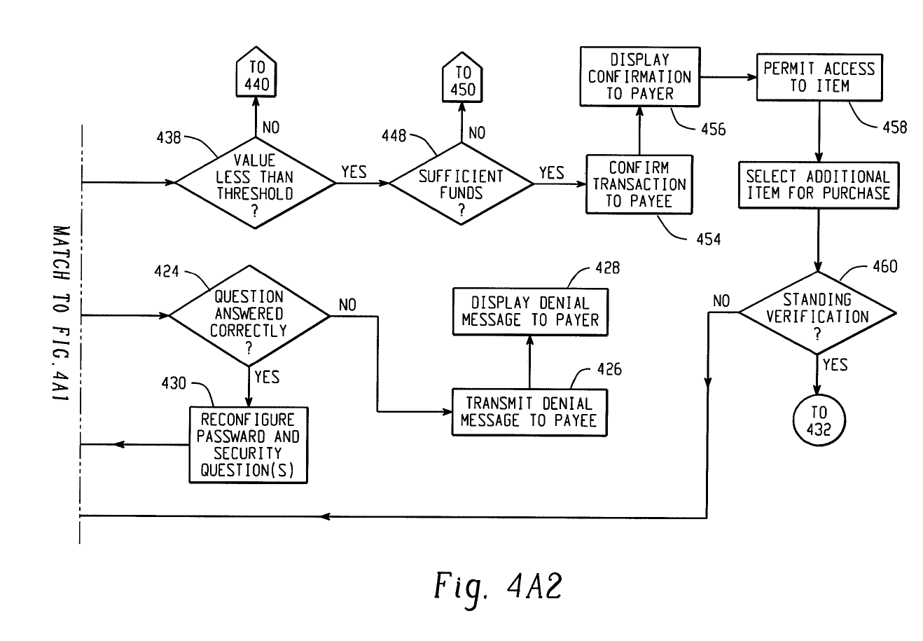

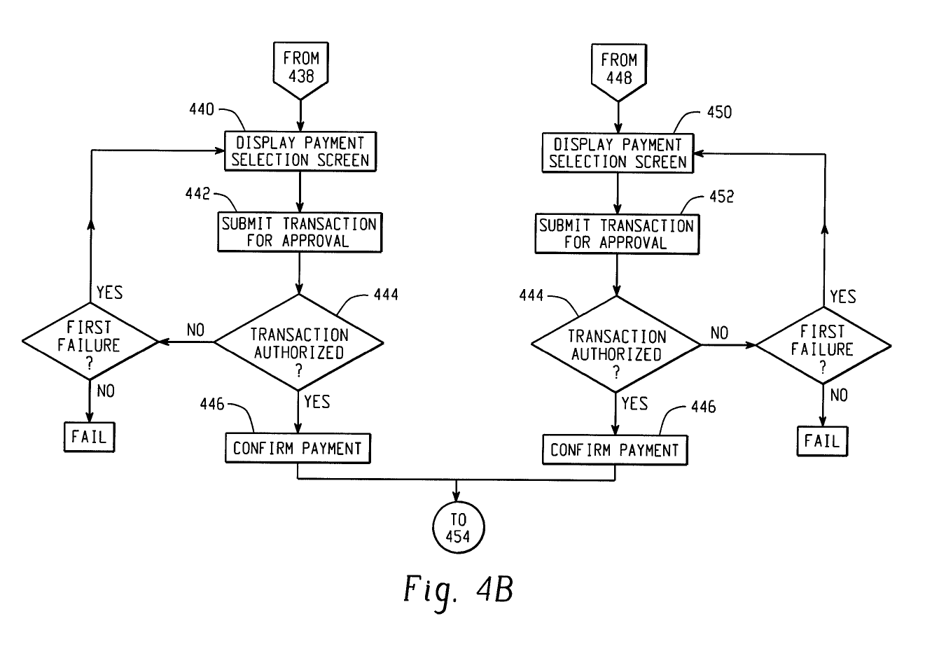

FIGS. 4A and 4B depict a flow diagram for an exemplary micropayment transaction performed on a payee website according to an embodiment. As shown in FIGS. 4A and 4B, a payer may access the payee website via a user interface, such as a web browser. The user interface may display 402 an item or service for purchase to the payer with a message offering the option to pay for the item using a micropayment processing system and a selectable micropayment icon if the item or service has a value below a threshold. In an embodiment, additional information may be displayed 402, such as a link to an information page describing the micropayment processing system. In an embodiment, the micropayment icon may be selected to initiate micropayment transaction processing.

Determinations may be made 404 as to whether the payer has previously registered with the micropayment processing system and whether the payee is a Trusted Merchant. In an embodiment, a payee may be required to submit to a qualifying process to be considered a Trusted Merchant. A payer may further be required to select a payee from a list of payees that have been qualified as Trusted Merchants in order for the payee to be a Trusted Merchant for that payer.

In an embodiment, a payer may elect to have a verification code or token stored as part of the payer's registered profile with a Trusted Merchant. The payer may make this request when interfacing with the Trusted Merchant or with the micropayment processing system (e.g. through Internet Banking or an interface facilitated to the micropayment processing system independent of a transaction by the Trusted Merchant). Upon receipt of a cardholder request, the micropayment processing system may provide a verification code or token to the Trusted Merchant for storage as part of the registered payer's profile. In an embodiment, the verification code or token may be generated in response to the payer's request so that it only verifies transactions by the payer made at the specified Trusted Merchant, may be provided to the Trusted Merchant in a fully encrypted form, and may only be decryptable by the micropayment processing system. In an embodiment, the token may allow session-based authentication. In another embodiment, the token may be used without session-specific authentication. When the payer performs a transaction with the Trusted Merchant, the payee may submit a payment authorization request accompanied by the payer's verification code or token to the micropayment processing system. The micropayment processing system may decrypt the verification code or otherwise verify a token upon receipt of the payment authorization request and provide an appropriate payment authorization response with all necessary data elements. The payee website may receive the payment authorization response and process the response as appropriate. In an embodiment, if the payer has previously registered, the Trusted Merchant may engage in a transaction with the registered payer without resubmitting identifying information for the parties, such as a password, an email address or the like.

If the payer has not previously been registered, a registration screen may be displayed 406 requesting profile information from the payer. For example, the payer may provide a name, address, telephone number, and/or the like. Once the payer provides 408 the requested information, a payment selection screen may then be displayed 410. The payment selection screen may enable the payer to select a payment type, such as a Visa®-branded credit card, the source details for the selected payment type and a load amount. In an embodiment, one or more selections for a load amount may be displayed via a pull-down menu. The micropayment processing system may submit 412 the load transaction to an external authorization service. If the transaction is not authorized, the micropayment processing system may display 410 the payment selection screen again. In an embodiment, if the load transaction fails a second time, the micropayment transaction may fail 414. If the load transaction is authorized, the micropayment payment system may display 416 a load confirmation screen, which requests, for example, a password and selections and answers for, for example, three security questions. In other examples, additional or alternate information may be requested from the user within the scope of this disclosure. In addition, an alternate number of security questions, other security verification methodologies and/or load transaction failures may also be included within the scope of this disclosure.

If the payer successfully completes the registration process or if the payer is determined to be registered, but the payee is not a Trusted Merchant, in step 404, the micropayment processing system may display 418 a purchase amount, a name for the payee and a description of the item for purchase. The system may further display 418, for example, a text entry field in which the payer is requested to enter an identifier, such as an email address, and a password corresponding to the entered identifier. A determination may then be made 420 as to whether the entered password corresponds to the identifier. If not, the micropayment processing system may display 422 one or more security questions pre-selected by the payer during the registration process. In an embodiment, the displayed security question may be selected randomly from the pre-selected security questions. The payer's answer to the displayed security question may be compared 424 with the answer provided during registration. If an improper answer is provided, a denial message may be transmitted 426 to the payee. The payee website may then display 428 a message requesting an alternate form of payment from the payer. If the proper answer is provided, the user may reconfigure and confirm 430 the password for the account and alternately select new security questions and responses. The process may then return to step 418.

If the entered password is determined 420 to correspond to the identifier or if the payer is registered and the payee is a Trusted Merchant in step 404, one or more further determinations may be made. For example, a determination may be made 432 as to whether the transaction amount falls within user-defined account parameters. Such parameters may include, for example and without limitation, whether the payee has been allowed and/or blocked, whether a total value limit is satisfied, whether the transaction satisfies value limits for the payee and/or whether the transaction satisfies time limitations for the account. Other account parameters may be defined within the scope of this disclosure on, for example, a per-payer, per-payee and/or per-account basis. Moreover, for transactions made by payers other than the primary payer for an account, a determination may be made 434 as to whether the primary payer has permitted the transaction. For example, a parent may set a limitation on transactions that a child performs using the account, such as the type, dollar amount or the like for such transactions. If any user-defined account parameters and/or primary payer parameter is not satisfied for a transaction, the payee website may display 436 a denial message to the payer and request that an alternate form of payment be selected.

If all parameters are satisfied, a determination as to the relationship between a transaction value and a threshold may be made 438. For example, if the transaction value is greater than and/or equal to a pre-defined threshold, a payment screen may be displayed 440 to the payer. The payment screen may include, for example and without limitation, one or more default payment sources and details, such as a masked account number, for each source. The payer may select a source and the transaction may be submitted 442 for external authorization. If the selected payment source authorizes 444 the transaction, a screen may optionally be displayed 446 to the payer listing, for example, the purchase amount, the payee name, a description of the purchased goods and/or services and the like. The payer may submit the payment without providing additional information.

If the transaction value is less than and/or equal to a pre-defined threshold, a micropayment processing system may be selected for processing the transaction. The micropayment processing system may determine 448 whether sufficient funds remain in the payer's account. If not, the micropayment processing system may display 450 a screen requesting that the payer add additional funds to the account from a default payment source, such as a credit card, a bank account, or the like. In an embodiment, the screen may present the default payment source with masked information, such as the last four digits of a credit card number, bank account number, or the like. In an embodiment, the payer may provide an alternate payment source. In an embodiment, amounts to add to the account may be presented in a pull-down menu or similar method having pre-selected amounts. In an embodiment, the screen may include a text entry field in which the payer may specify a particular amount. Once the payer specifies an amount to add to the account, the micropayment processing system may submit 452 the load transaction for external authorization by the selected payment source. If the selected payment source authorizes 444 the transaction, a screen may optionally be displayed 446 to the payer listing, for example, the purchase amount, the payee name, a description of the purchased goods and/or services and the like. The payer may submit the payment without providing additional information.

If sufficient funds remain in the account or are added to the account, a transaction confirmation may be provided 454 to the payee website. The payee website, upon receipt of the confirmation from the micropayment processing system, may display 456 a confirmation message to the payer and permit 458 access to the goods and/or services. In an embodiment, if the payer desires 460 to purchase additional goods and/or services, the micropayment purchase process for such additional goods and/or services may skip to, for example, step 432. In an embodiment, the micropayment purchase process may skip to step 432 only if the additional goods and/or services are sought to be purchased during a single access session. In an embodiment, a payer may be required to provide a password again if, for example, a payer does not make a purchase within a pre-defined time period of a previous purchase, a payer has accessed a different website or the like. Alternately, the micropayment purchase process may skip to step 432 if the payee is a Trusted Merchant.

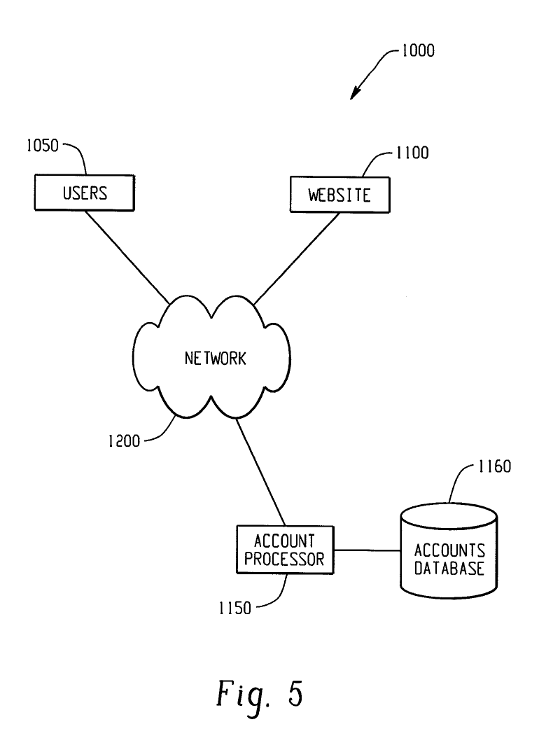

FIGS. 5-48 illustrate examples of systems and methods for providing sponsored accounts for a computer-implemented payment system. A sponsored account system may be used to provide users that are not eligible or are unwilling to directly hold electronic payment accounts with a way to purchase items with electronic payments. Alternatively, a sponsored account system may be used for other purposes, such as for gifts or payments to other users, even those that are eligible for their own electronic payment accounts. As another example, the sponsored account system may be used in other situations, such as employee-employer situations, wherein the primary account holder desires to have a measure of control over the sponsored account holder's purchases.

FIG. 5 shows a block diagram of an example transaction processing system 1000. System 1000 can be a computer-implemented environment wherein one or more users 1050 can interact with one or more websites 1100 through a network 1200. For example, the user may wish to engage in a financial transaction with the website, may wish to receive access to restricted information or functionality available via the website, or may wish to engage in similar or related interactions with the websites. In order to facilitate the interactions with the websites, the user establishes one or more primary and sponsored accounts in an accounts database 1160 with the account processor 1150 via the network 1200. The user may establish the one or more accounts with the account processor prior to visiting the websites or may be redirected from the website to the account processor for purposes of establishing one or more accounts.

In various embodiments described more fully below, the one or more primary and sponsored accounts may be used to conduct a financial transaction with a website. For example, the one or more primary and sponsored accounts may be used to purchase goods and/or services from the website. In this embodiment, the user 1050 may navigate to the website 1100 to initiate a financial transaction, such as the purchase of goods or services. The primary account holder selects one of the one or more external funding sources maintained with the account processor 1150 to be used as part of the financial transaction, and the primary account holder is then authenticated to the website via the account processor. The sponsored account does not require any outside funding sources to make a purchase. The one or more external funding sources may be prepaid accounts, stored value accounts, credit accounts, debit accounts, or the like. In one embodiment, the prepaid accounts may be useful for conducting low value transactions in a manner which increases profitability for the seller. In another embodiment, the account may be a credit, debit or other account, or an alias for such an account that may be more appropriate for higher valued transactions. The sponsored account is funded only by funds received from the primary account.

The one or more accounts may alternately be health care related accounts that enable the user to access health care related information on the website, to conduct health care related transactions, or to otherwise manage and/or acquire health care related products and/or services. In a further embodiment, the one or more accounts may enable the user to access any type of restricted access information or functionality on the website and/or to engage in a transaction related to such restricted access.

The account processor 1150 may comprise one or more servers containing software operations or routines for creating and maintaining accounts for the users; for enabling the users to conduct transactions with one or more websites; for enabling users to initiate dispute proceedings with one or more websites and to automate the communications related to the dispute and the resolution of the dispute; to initiate and transmit alerts to users, websites, and or system administrators based upon pre-defined and/or customizable parameters; to configure and apply fees to all transactions; and to conduct reporting as may be relevant to the websites, the account processor and/or the users. Furthermore, the one or more servers of the account processor may additionally contain software operations or routines related to managing the accounts (such as by updating billing addresses, delivery addresses, user preferences, and the like); for enabling users to authorize and manage recurring payments or to pre-authorize payments; for enabling users to pre-authorize (i.e., whitelist) or prohibit (i.e., blacklist) websites and/or transactions; and/or for enabling users to manage accounts and conduct transactions using mobile electronic devices or any other electronic device such as internet-connected gaming consoles, a digital set-top box, or similar devices. The accounts database 1160 may comprise one or more memory devices. In certain examples, the accounts database 1160 may be comprised of a plurality of disbursed memory devices. In another example, the accounts database 1160 may include one or more memory devices that are included within the same one or more servers as the account processor 1150.

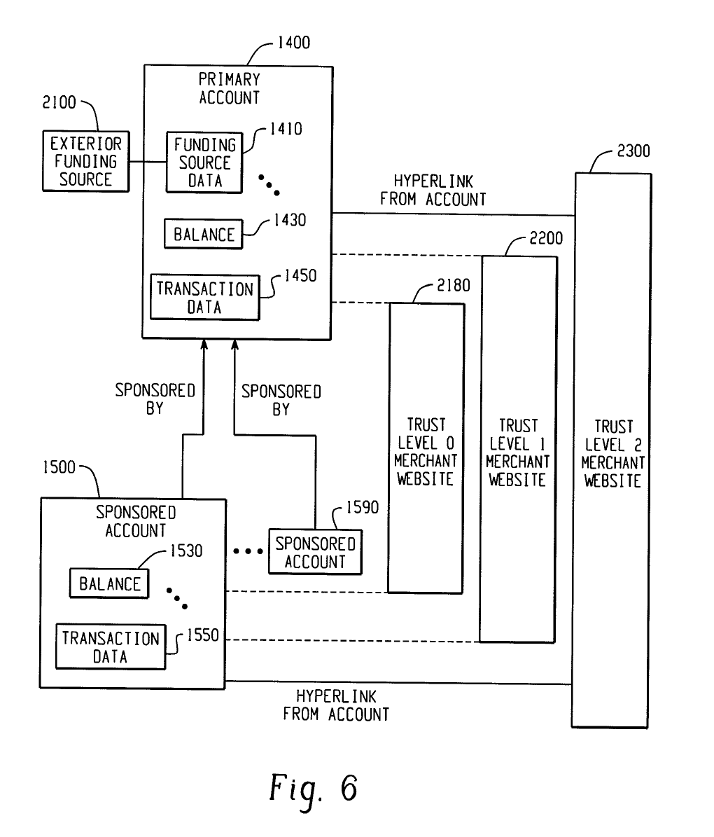

FIG. 6 shows example data structures for sponsored accounts 1500, 1590 that are sponsored by a primary account 1400. A user having a primary account 1400, which is funded by an external funding source 2100, can sponsor one or more sponsored accounts 1500, 1590 for use by others, such as children, friends, relatives, employees, etc. In one embodiment, the system of primary 1400 and sponsored accounts 1500, 1590 are hosted on a website, and the account data 1410, 1430, 1450, 1530, 1550 are stored in an accounts database, such as a database associated with the website. From the primary 1400 and sponsored accounts 1500, 1590 the users are able to make purchases from merchant websites 2180, 2200, 2300. The setup, operation, and closing of the sponsored accounts is discussed herein.

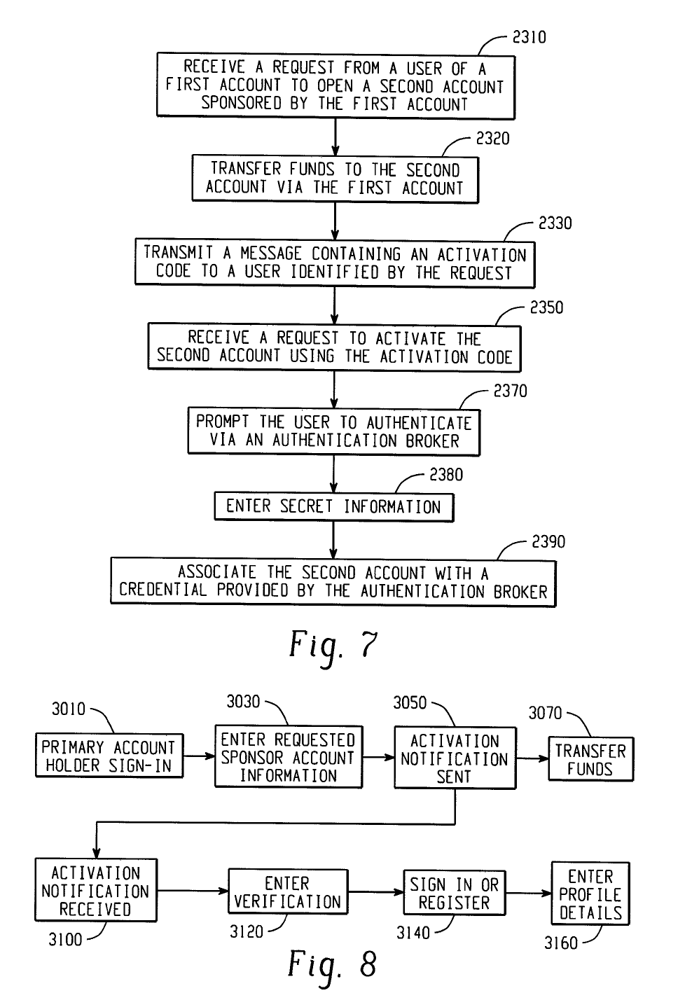

FIG. 7 shows an example of a method to setup a sponsored account. In FIG. 7 a computing apparatus (e.g., a website) receives (step 2310) a request from a user of a primary account to open a sponsored account. The request may specifically identify the user of the second account and an address to contact the user of the second account, such as an email address, a mobile phone number, an instant messaging identifier, etc. Funds may then be transferred to the second account via the first account (step 2320). The computing apparatus then transmits (step 2330) a message containing an activation code to the user of the second account. When the computing apparatus receives (step 2350) a request to activate the second account using the activation code, the computing apparatus prompts (step 2370) the user to authenticate via an authentication broker (e.g., a website). If the user does not already have an account with the authentication broker, the user may establish one at this time. The method may also require entry of some type of secret information known to both parties, such as the email address or mobile phone number of the primary account holder (step 2380). Once the user is authenticated by the authentication broker and the secret information has been successfully entered, the computing apparatus associates (step 2390) the second account with a credential provided by the authentication broker. Subsequently, the user of the second account can access the second account via authenticating with the authentication broker. Funds may then be transferred to the second account via the first account (step 2410).

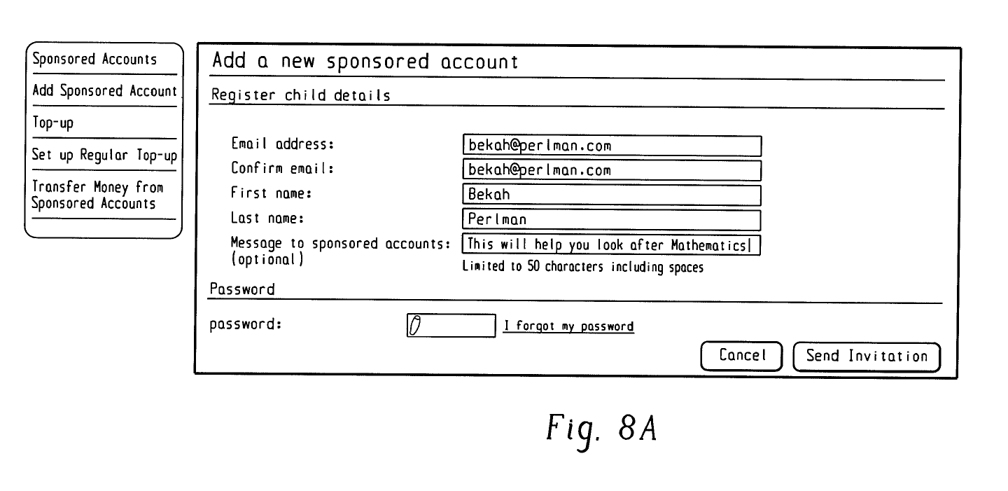

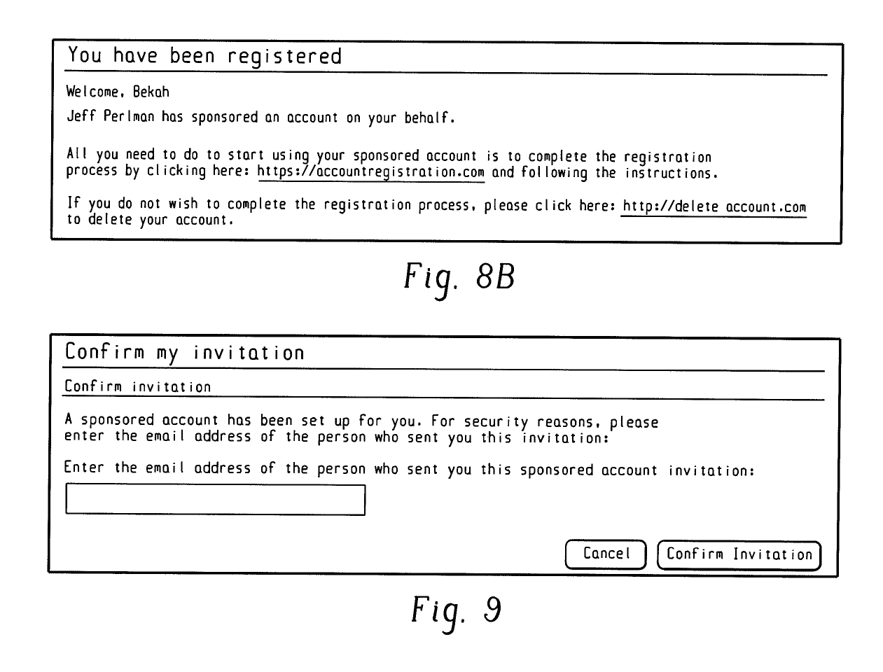

FIG. 8 shows an expanded example method to open a sponsored account. A user of a primary account signs in to the primary account (step 3010). For example, the primary account holder may sign in on a website using a user name and password combination.

Next, the primary account holder requests that a sponsored account be created, and provides information necessary to open the account (step 3030). For example, the primary account holder can input the request on a website user interface, and provide information for opening the sponsored account for an identified user. The information may include the name and email address of the identified user, a mobile phone number, an instant messaging identifier, etc., of the identified user. The primary account holder may also write an optional message to the identified user to be sent with the notification. In one example, the system will check if the identified user's contact information is already registered with the system (e.g. for another sponsored account or for a primary account). In one example if the contact information is already registered, the primary account holder will be notified and prompted to try submitting the information again.

FIG. 8A shows an example of a graphical user interface for implementing step 3030. The primary account user selects “Sponsored Accounts” from a navigation menu. The user then selects “Add New Sponsored Account” from a separate sub-menu. A form is then displayed where the user enters an e-mail address for the sponsored account user, re-enters the e-mail, enters the first name and last name of the sponsored account user, enters an optional “Message to sponsored accounts,” and then clicks a “Send Invitation” button to initiate the sponsored account notification.

In the next step, a computer takes the information provided in the previous step and sends a notification to the user who was identified to receive the sponsored account (step 3050). For example, the notification may be an e-mail, SMS, or other electronic communication. The notification includes instructions and information, such as an activation code, to complete registration of the account. A link to a website user interface for accessing the account that incorporates the activation code may be included in the notification. The notification may also include instructions for denying the offer of the sponsored account, such as a link to delete the account.

If the offer of the sponsored account is denied, then the primary account holder may resend the notification in the future. The graphical user interface may present the resend option to the primary account holder at a later time. Furthermore, in one example, if the sponsored account is denied, any funds that have been transferred from the primary account to the sponsored account will be returned to the primary account and the primary account holder will receive an email notifying them that the sponsored account was denied.

In one example, the primary account holder has the option to transfer funds from the primary account to the new sponsored account (step 3070) as soon as the notification is sent, or as soon as it is received by the identified user. The primary account holder can also set up automatic fund transfers from the primary to the sponsored account at certain intervals or dates in the future. In another example, the sponsored account is not opened until the identified user follows the instructions to complete the registration of the sponsored account. In this example the primary account holder may be required to wait to perform the fund transfer until another time; for example, until the sponsored account holder has registered as discussed below.

The user identified to receive the sponsored account receives the notification sent in step 3050 (step 3100). FIG. 8B shows an example of the notification received by the identified user, including a link to complete the registration and a link to delete the sponsored account. The identified user can then follow the instructions contained in the notification, such as clicking on a link provided to the website user interface, for accessing the account electronically.

As a confirmation and security hurdle, the identified user may be required to enter verification information in the website user interface that identifies the notification and/or the user that sent the notification (step 3120). The verification information may be an activation code and/or an e-mail address. The verification information, such as an activation code, may be contained in a link present in the notification. In one example, the activation code embedded in the link is based on a hash of the primary account holder's e-mail address and account ID. A computer may automatically verify this activation code before allowing the registration process to continue. In another example, the e-mail address of the primary account holder may be required to be entered by the identified user as an additional security hurdle to the verification code. This provides an additional degree of authentication by requiring the identified user to enter some information that is not included in the activation notification. If an unauthorized user gained access to the invitation notification, they would not be able to complete the registration without knowing the e-mail address of the primary account holder. FIG. 9 shows an example graphical user interface for entering the appropriate e-mail address.

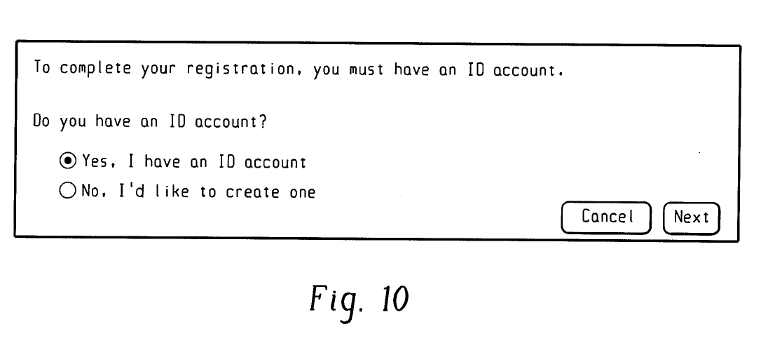

Next, the identified user may sign in with a user ID and password from an already established electronic account, or they may register for an account (step 3140). The account may be specific to the primary/sponsored account system or may be a general internet account, such as an OPEN ID account. In one example, the website will check for a cookie from the general internet account, and if found, it will accept the logged in session state, thereby eliminating the need to log-in again. FIG. 10 shows a graphical user interface for selecting to sign-in or create an account.

In another example, the verification page of step 3120 is presented after the identified user has logged in (step 3140).

Finally, the identified user may enter additional remaining details in a user profile (step 3160), such as setting up a password to make purchases. Profile information includes an e-mail address and name, which may be pre-populated from the information entered by the primary account holder, but can be modified or confirmed by the identified user. Terms and conditions may be presented for acceptance at this step. Finally, the identified user finishes the registration process by submitting all the profile information; for example, by clicking on a Create Account button in a graphical user interface. The identified user thus becomes the sponsored account holder.

At this point the registration is complete and any funds transferred by the primary account holder are instantly available for use in transactions with merchant websites by the sponsored account holder.

If the identified user cancels the registration process before completing it, the identified user can complete the registration at a later time, simply by following the instructions in the notification starting at step 3100, such as by clicking again on the link in the invitation email they received. In one example, attempts to close or navigate away from the registration website will result in a notification of how the registration process may be restarted if the user abandons it.

Returning to FIG. 6 and its depiction of the primary and sponsored account system, the funding and operation of the sponsored accounts 1500, 1590, and the primary account 1400 will be discussed.

In one example, the primary account 1400 stores funding source data 1410, such as information about a credit card account, a debit card account, a bank account, etc. The sponsor uses the funding source 2100 as identified by the funding source data 1410 to replenish the primary account 1400 when the balance 1430 of the primary account 1400 is low or insufficient for a purchase. In some embodiments, a user of the primary account 1400 may directly use the external funding sources 2100 identified by the funding source data 1410 to make purchases.

In contrast to the example primary account 1400, the example sponsored accounts 1500, 1590 do not have funding source data 1410. The sponsored accounts 1500, 1590 obtain funds via the primary account 1400. In one example, the sponsored accounts 1500, 1590 are restricted from having funding source data 1410 of their own. In situations where the sponsored account holders are children, the sponsored account holders may not be eligible for funding sources 2100 of their own to provide funding source data 1410. In one example, the sponsored accounts 1500, 1590 are also not eligible to receive funds from any peer-to-peer transactions.

In one embodiment, the account 1400 of the sponsor stores the funding source data 1410, such as information about a credit card, a debit card, a bank account, etc. The sponsor may use the funding source 2100 as identified by the funding source data 1410 to replenish the account 1400 when the balance 1430 of the account 1400 is low or insufficient for a purchase. In some embodiments, a user of the account 1400 may directly use the funding sources 2100 identified by the funding source data 1410 to make purchases.

In one example, the sponsored accounts are under the control of the primary account. The primary account holder (or sponsor) may use the primary account 1400 to manage the sponsored accounts 1500, 1590. Several management tools are provided to the sponsor, including the ability to: view the transaction data 1550 in the sponsored account 1500, view the balance 1530 of the sponsored account 1500, withdraw funds from the sponsored account 1500, schedule regular deposits to the sponsored account 1500, top up the account 1500 (i.e., making a deposit, or bringing the balance 1530 of the sponsored account 1500 to a predetermined level), etc. In some examples, the system may block the sponsor from accessing certain information in the sponsored account 1400, such as the transaction data 1550. This may occur, for example, when a set of predetermined criteria are satisfied (e.g., the age of the user of the sponsored account is above a threshold, and/or the primary account holder agrees with the blocking, etc.) In one example, sponsored accounts 1500, 1590 can only have funds decremented through purchases or through sponsor-initiated transfer from the sponsored account 1500, 1590 to the primary account 1400. Sponsored accounts can only be used for transactions from the balance 1530, no pass-through transactions (i.e., transactions funded by a third-party financial instrument) are allowed. That is, no external funding sources 2100 may be used to make transactions.

In contrast, a sponsored account holder does not have access to the information stored in the primary account 1400, such as the balance 1430 and transaction data 1450, etc.

In one example, there can be balance and other restrictions. For example, the total balances of the primary account 1400 and all sponsored accounts 1500, 1590 under that primary account 1400 are treated as a single balance for the purpose of risk-based account maximum balance restrictions and other legal and regulatory purposes.

A primary account 1400 is supplied with funds from funding sources 2100 such as checking, savings, or credit card accounts. These funding options are accessible to the sponsor through a graphical user interface, for example a “manage funds” webpage that allows the sponsor to transfer funds into and out of the primary account 1400. In contrast, in one example, the sponsored account 1500 does not have the option to import additional funds from external accounts, but receives its funds solely from the primary account 1400. In one example, the sponsored account 1500 cannot make withdrawals from the balance 1530, such as via transfers to external accounts. In one example, the sponsored account 1500 does not even have an option to associate external accounts with the sponsored account 1500, such as via the “manage funds” webpage that is available in the primary account.

FIG. 11 shows an example graphical user interface webpage for the sponsored account 1500. In this example, the account summary page shows a transaction history reflecting the stored transaction data 1550 for the sponsored account 1500. Options are provided for adjusting the date range of the transaction history, and selecting the transaction type and status. An account balance is also presented on this page, in addition to information regarding regular account deposits or top-ups. In the example of FIG. 11 a deposit of $20 will be made every Thursday.

Navigation menu items are also provided for “Express Sellers” (i.e., Trusted Level 2 sellers), and “Edit Profile.” In the “Edit Profile” menu the user may make changes to their profile information. An example of profile information is the information that was entered at step 3160 of the registration process.

In one example, sponsor accounts cannot have their own sponsored accounts.

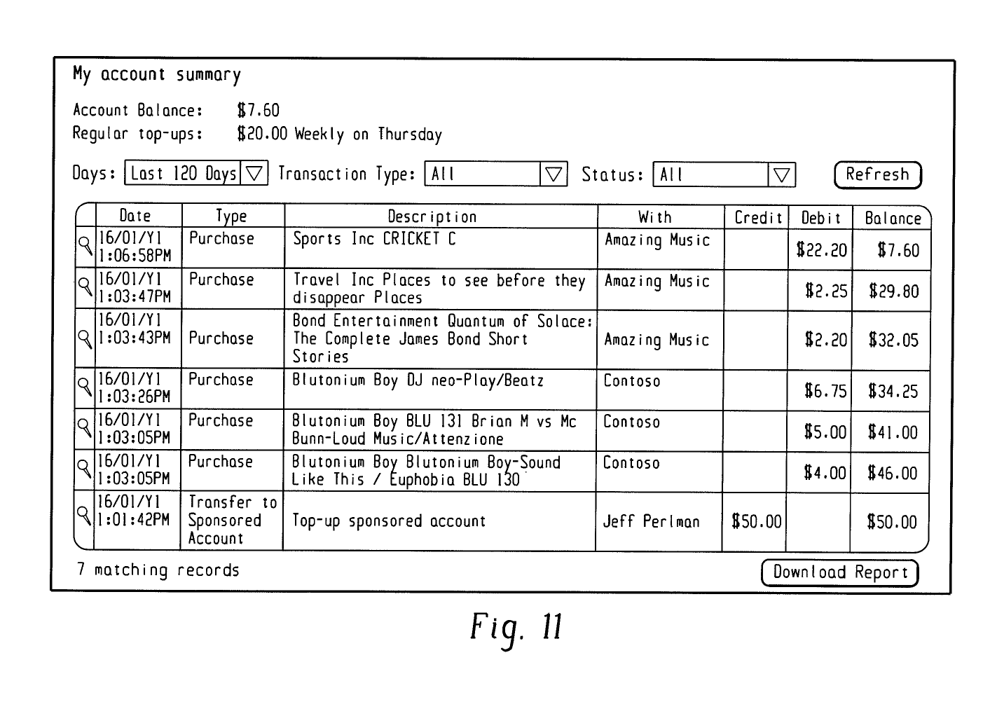

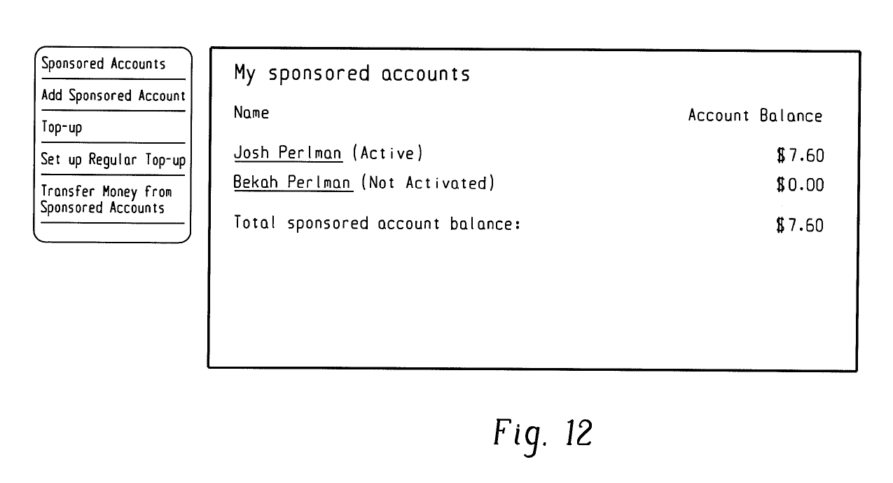

FIG. 12 shows a portion of an example graphical user interface webpage for the primary account 1500. Under the “Sponsored Account” menu item, the sponsor is presented the names of the sponsored account holders, the status of the sponsored accounts 1500, 1590 (active, inactive, or closed), and the account balance of each account 1530. The inactive account 1590 has not yet been activated by the above-described registration procedure. The total sponsored account balance is also presented. On this page, the sponsor can select any sponsored account name to view the specific sponsored account summary page.

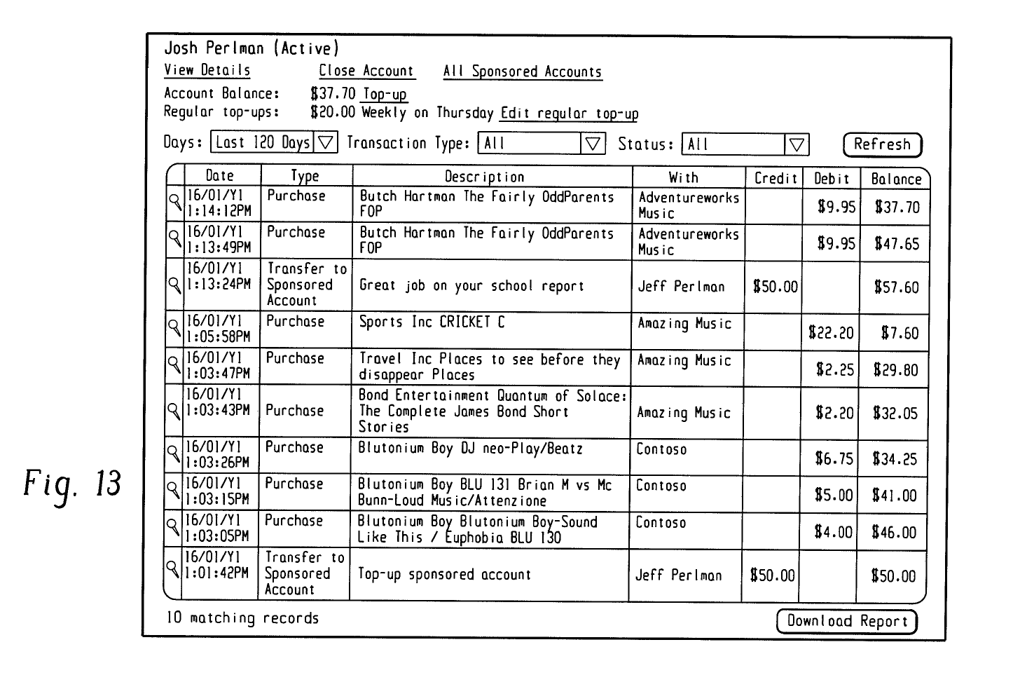

FIG. 13 shows an example graphical user interface for the Sponsored Account Summary page, which includes the transaction history formulated from the transaction data 1550. The transaction history is identical to that presented to the sponsored account holder in the sponsored account graphical user interface.

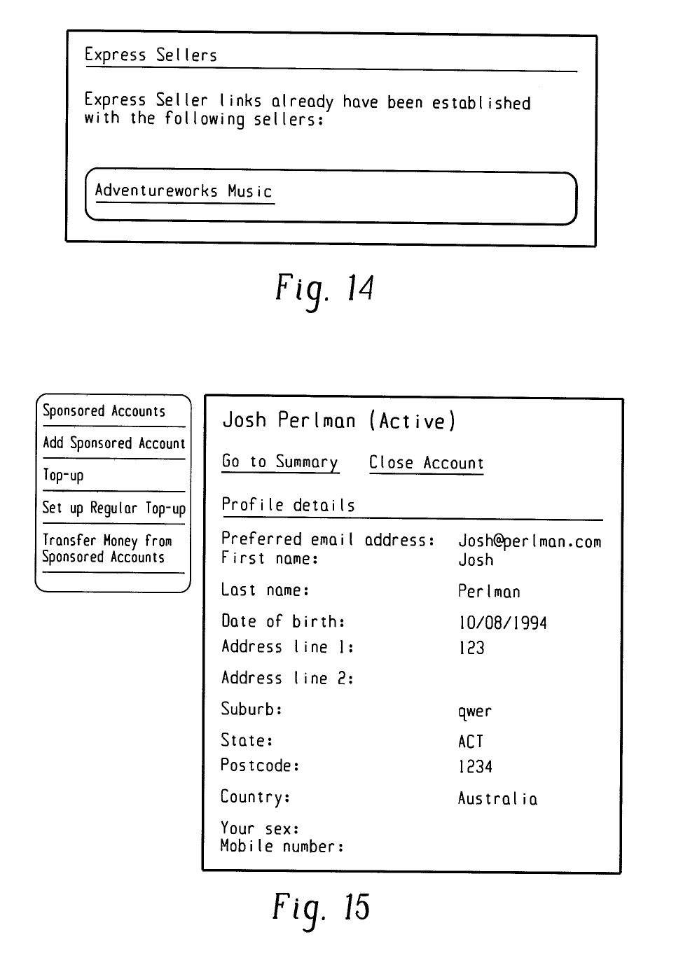

The list of express seller relationships (described in more detail below) that exist for the sponsored account 1500 is also available to be viewed by the sponsor. FIG. 14 shows an example of a graphical user interface for displaying the trusted level 2 sellers (e.g., express sellers).

The user can click on View Details in the Sponsored Account Summary page to see the registration details for the Sponsored Account, which includes all details except password and Security Questions. These details are not editable by the sponsor. FIG. 15 shows an example of a graphical user interface for the View Details webpage. From the View Details page, the user can click on “Go to Summary” to return to the Sponsored Account Summary.

There is an option to close the account on both the “View Details” page and the Sponsored Account Summary page.

The user can click on “All Sponsored Accounts” in the Sponsored Account Summary page to return to the summary page under the “Sponsored Account” menu item shown in FIG. 12.

Accordingly, all sponsored account transactions, profile details, and Express Seller lists are fully visible to the sponsor through the sponsor's primary account graphical user interface. However, in one embodiment the sponsor cannot modify these items. However, if a sponsored account holder changes the e-mail under which a sponsored account is registered, upon successful verification of this e-mail, the sponsor is notified of this change, such as via e-mail.

Sponsored accounts 1500, 1590 can have account suspensions applied to them independent of the primary account 1400, such as, for failing to comply with terms of service, account non-use, etc. However, any primary account suspension automatically applies to all sponsored accounts 1500, 1590 under the primary account 1500.

Returning to FIG. 12, the graphical user interface shows menu options labeled “Top Up” and “Set up Regular Top-Up.” These options are how the sponsored accounts 1500, 1590 are funded whether they are active or not activated yet.

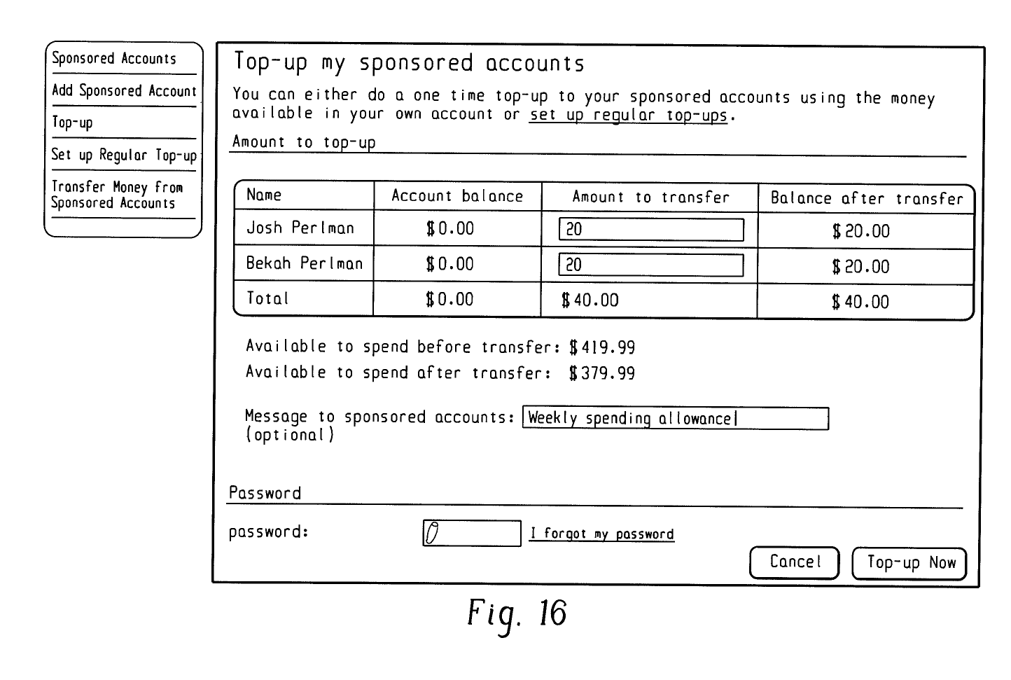

FIG. 16 shows an example graphical user interface page titled “Top up my sponsored accounts,” which is accessed by clicking on the “Top Up” menu item shown in FIG. 12 or 13. On this page the sponsor enters the amount to transfer to each of one or more sponsored accounts 1500, 1590. The sponsor is able to see the total fund transfers as well as the funds available in the primary account 1400 before the transfer, and what will be available in the primary account 1400 after the transfers. Should the total to be transferred exceed the funds available in the primary account 1400, an insufficient funds message is displayed as the amounts are entered, prompting the sponsor to either reduce the amount to be transferred or to top-up the primary account 1400 from one of the external funding sources 2100 before proceeding.

The primary account holder can also enter an optional message to the sponsored account holder(s) that will be displayed in the “Description” field of the line item for the top-up in the transaction history.

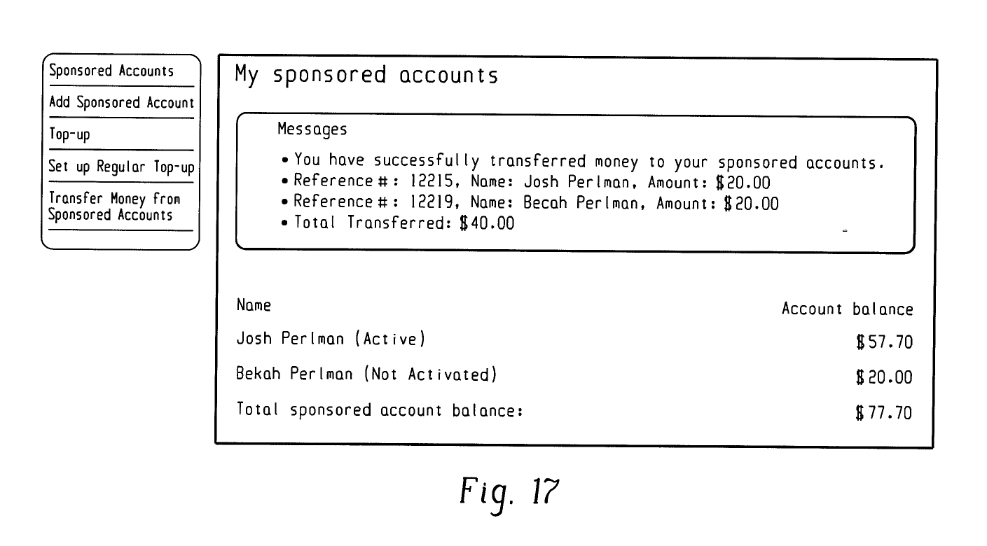

To make the transfer, the primary account holder enters a password and clicks on the item “Transfer Funds Now,” resulting in a confirmation message on the Sponsored Accounts Summary page. FIG. 17 shows a graphical user interface showing the confirmation message for the transferred funds.

In one example, funds are instantly available in the sponsored account in the “active” state 1500 and instantly available upon activation for sponsored accounts in the “Not Activated” state 1590. If a “Not Activated” sponsored account invitation is declined by the sponsored account holder, then any funds loaded are automatically returned to the primary account 1400.

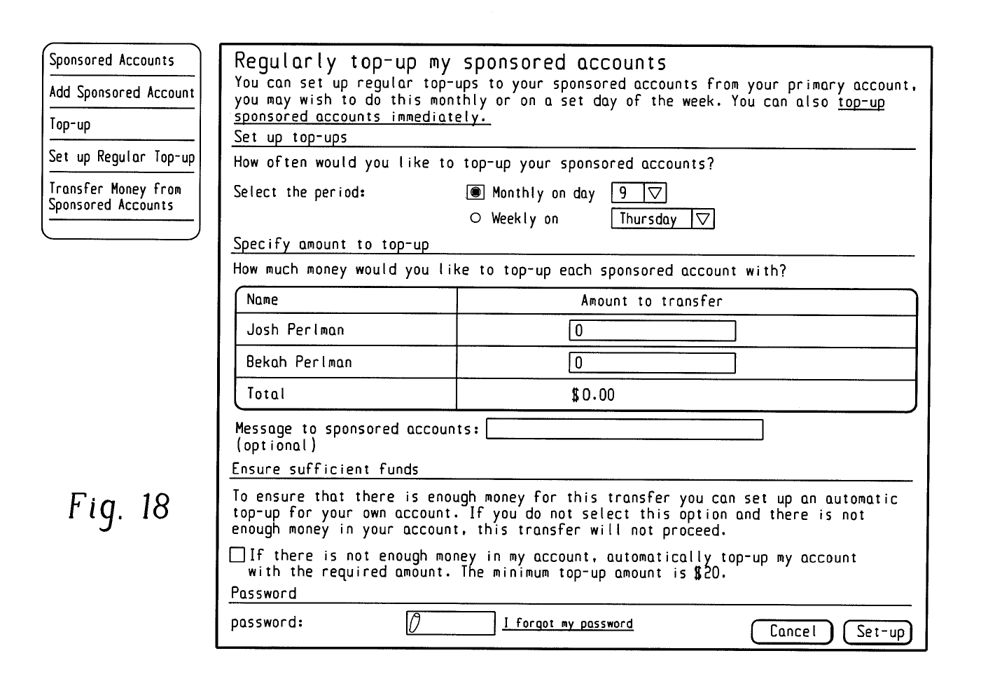

FIG. 18 shows an example graphical user interface page titled “Regularly top-up my sponsored accounts,” which is accessed by clicking on the “Set-up Regular Top Up” menu item shown in FIG. 12. From this page, primary account holders select the desired frequency and date of the deposits; for example, weekly and day of week or monthly and day of month. The amount to transfer to each sponsored account 1500, 1590 is also selected on this page. As in the one time top-up option, the primary account holder can also enter an optional message to the sponsored account holder(s) that will be displayed in the “Description” field of the line item for the top-up in the transaction history.

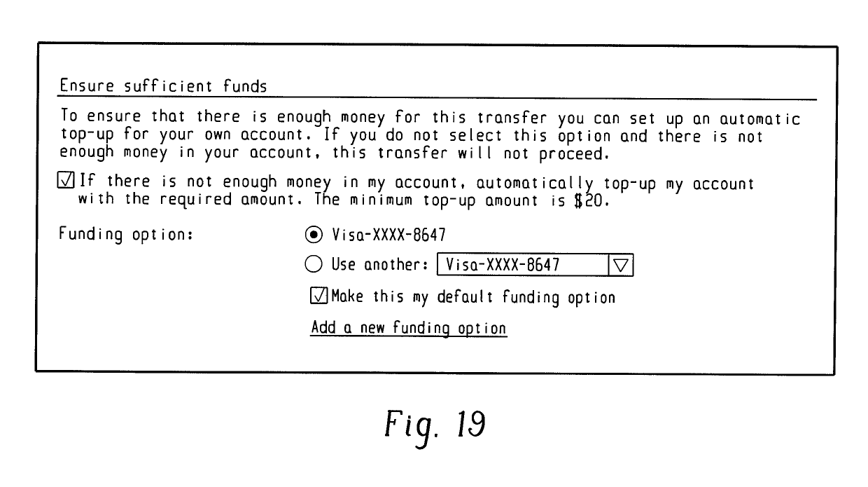

An option is also provided to the primary account holder to automatically top-up their own account if sufficient funds are not available for the sponsored account automatic transfers on the transfer day. When this option is selected, the primary account holder is given the option to choose which funding source 2100 to use. FIG. 19 illustrates a graphical user interface for selecting which funding source 2100 to use for the periodic top-up. In one example, bank accounts are not available in this selection because these funds need to be available immediately. In one example, the associated top-up is a minimum amount, such as $20, or the difference between the transfer amount and the account balance, whichever is greater.

If the automatic top-up to the primary account 1400 fails, then the automatic top-up to the sponsored accounts 1500, 1590 will also fail, and both accounts will see the relative top-up failures in their respective transaction histories. The primary account holder will see both failures.

If the funding source 2100 that a sponsor uses to top-up the primary account is deleted, the primary account holder will be prompted to associate the sponsored account top-up with an alternate funding source 2100. If no alternate funding sources 2100 are selected or none are available, then the top-up associated with the sponsored account automated top-up will be deleted.

As with the one-time top-up, to confirm the regularly scheduled transfers, the primary account holder enters a password and clicks on the item “Transfer Funds Now,” resulting in a confirmation message on the Primary Accounts Summary page. After being set-up, the regular top-up is reflected on the primary account holder's view of each sponsored account 1500, 1590 as well as on the sponsored account holder's main account summary page (See FIG. 13).

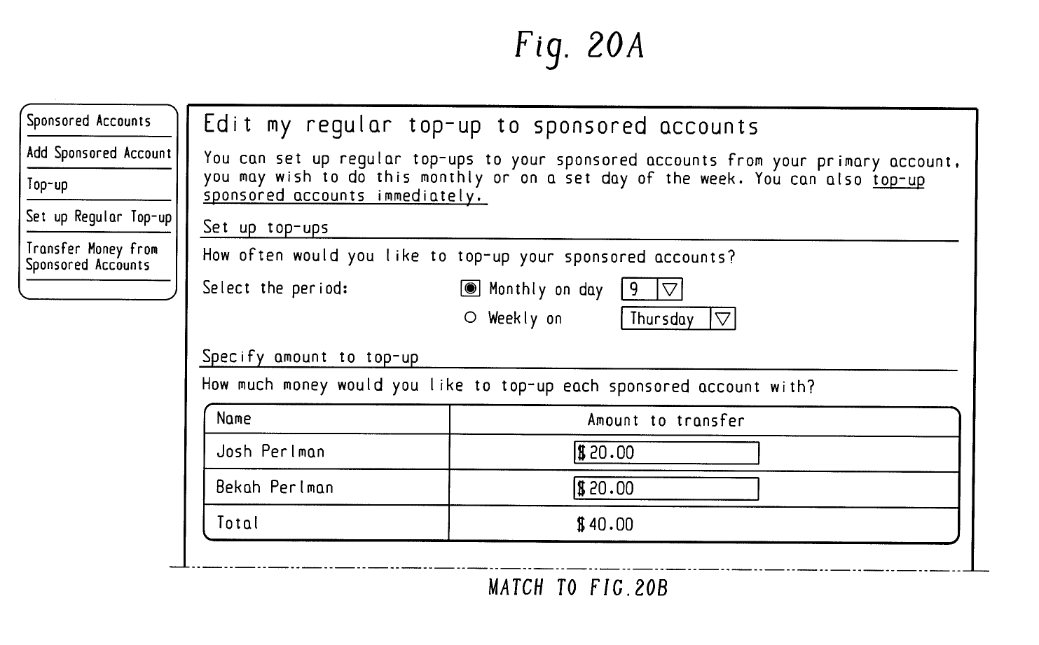

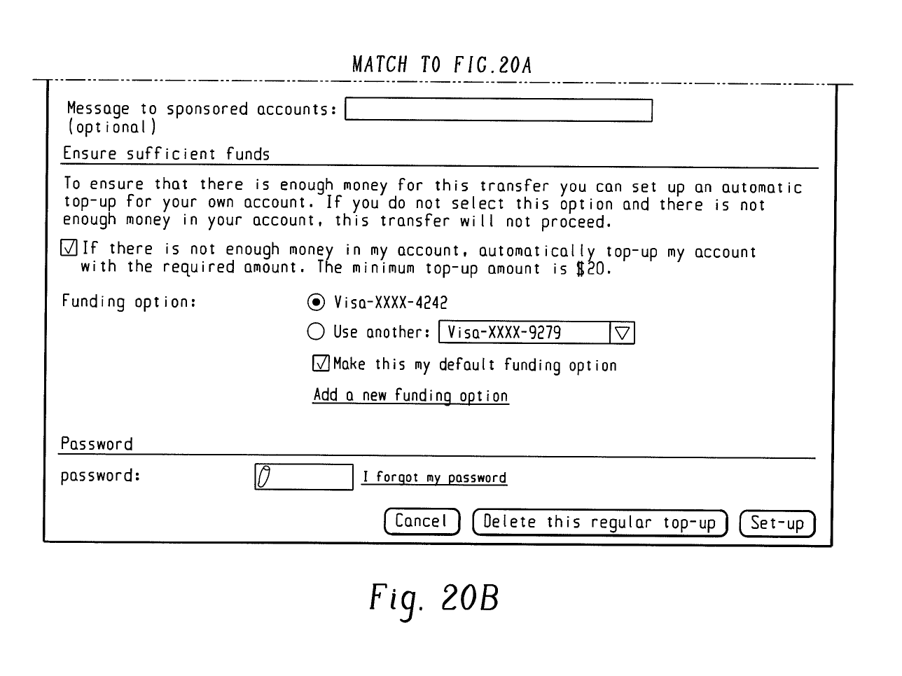

The scheduled top-up to sponsored accounts can be edited by clicking on the “Edit regular top-up” link on the Sponsored Accounts account summary page (FIG. 13) or by clicking on the Set up Regular Top-up item in the left-hand navigation menu under Sponsored Accounts (FIG. 12). A page similar to FIG. 18 will be displayed, providing the same options, but with the previously selected amounts and options pre-filled in the editable form, such as is shown in FIG. 20, which shows an example graphical user interface page for editing the periodic top-up. The sponsor can delete the regular top-up to sponsored accounts by clicking on the “Delete this regular top-up” button. In this example this option requires entry of the password and will immediately cancel the standing order. The sponsor can also make modifications to the settings, which will also require entry of the password prior to clicking on the “save” button. Editing and saving the new settings will overwrite the previous standing order with the new order settings. After completing the above, the user will see a confirmation message.

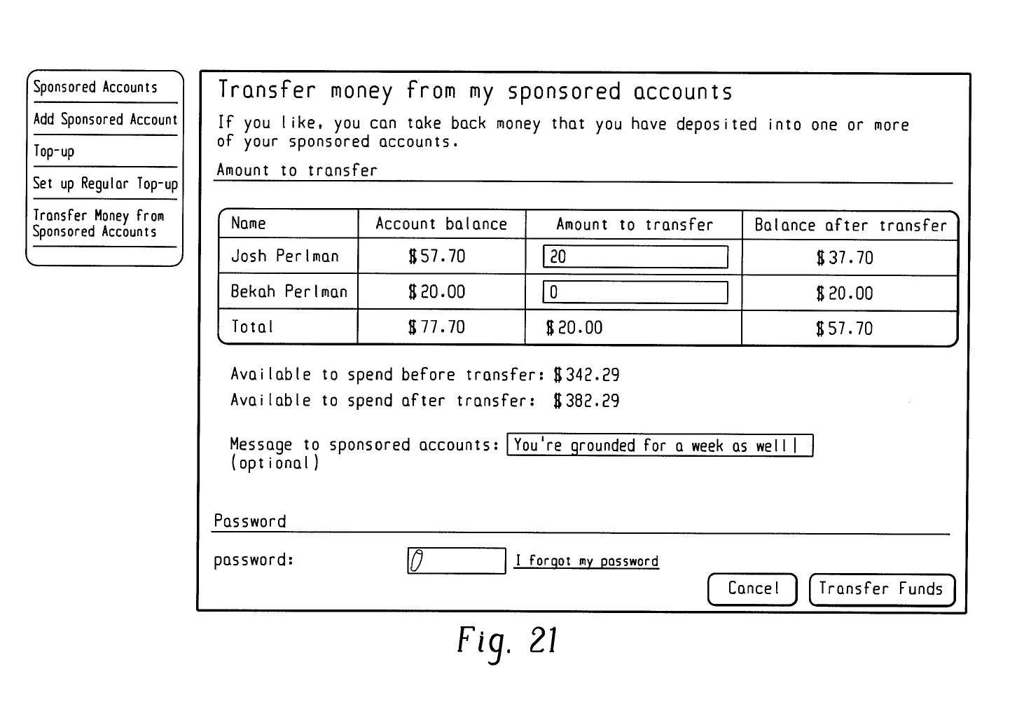

In one example, the sponsor may retrieve funds from one or more sponsored accounts 1500, 1590. To do this, the sponsor selects “Transfer Money from Sponsored Accounts” under the Sponsored Accounts menu, as shown in FIG. 12. FIG. 21 shows an example graphical user interface page for transferring money from sponsored accounts 1500, 1590. In the page shown in FIG. 21, the sponsor enters an amount to transfer up to the balance 1530 in each sponsored account 1500, 1590, and funds available before and after the transfer are displayed. If the amount entered exceeds the sponsored account balance 1530, then an error message appears. As with deposits to the sponsored accounts 1500, 1590, the sponsor can then enter an optional message to the sponsored account holder(s) that will be displayed in the “Description” field of the line item for the transfer of funds in the transaction history. To confirm the transfer the sponsor enters the password and clicks on “Retrieve Funds Now.” Funds are immediately removed from the sponsored account 1500, 1590 and are added to the available balance in the primary account 1400.

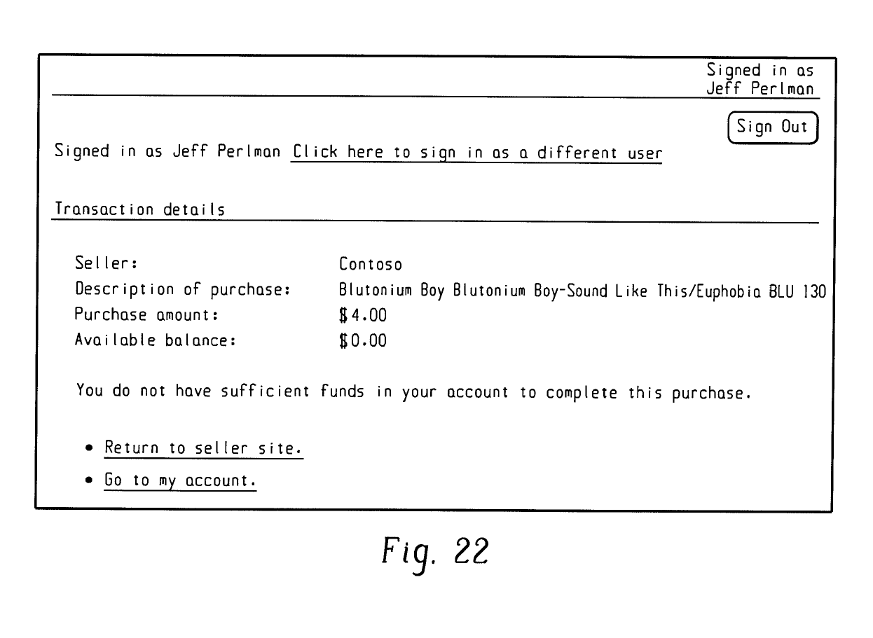

The sponsored accounts holders may make electronic purchases from internet websites. In one example, the sponsored accounts 1500, 1590 may only make purchases if there is a sufficient balance 1530 in the account 1500, 1590 for the purchase price. No external funding sources 2100 are allowed to the sponsored accounts 1500, 1590 to supplement the balance 1530 or make pass-through transactions. In the situation where a sponsored account holder attempts to make a purchase for which they do not have a sufficient balance 1530, a page, such as the page shown in FIG. 22, will be displayed that will explain that the user has insufficient funds. This page will not provide any options for the user to complete the transaction because a sponsored account does not have any external funding sources 2100. This page does, however, provide link options to either return the sponsored account holder to the seller site, which will result in an “insufficient funds” message being posted back to the seller, or to go to the user's sponsored account page, e.g. the page shown in FIG. 13.

In one example there are at least three categories of internet merchant websites 2180, 2200, 2300, which may be designated as standard (Trust Level 0), express session (Trust Level 1) and an express seller (Trust Level 2). For a standard merchant 2180, the user may be required to enter a password for each transaction. For an express session merchant 2200 the user can establish a trusted session with the merchant's website 2200, wherein a password is input one time, but need not be input again as long as the session is active. While the trusted session is active, keyboardless transactions may be made. For an express seller merchant 2300 the user can establish a trusted relationship with the merchant's website 2300, wherein a password is input one time, and then does not need to be entered again for multiple sessions. As long as the user is logged into a merchant account with which an express seller has a relationship, a password does not need to be entered at all to make a purchase from an express seller merchant website 2300, such as a keyboardless transaction purchase.

In an example, links to express seller merchant websites 2300 are accessed through the sponsored account graphical user interface. For example, see FIG. 11, which shows an “Express Sellers” menu tab that when selected would display links to express seller merchant websites 2300.

Both primary accounts 1400 and sponsored accounts 1500, 1590 may make purchases from standard (trust level 0), first and second trust level merchant websites 2180, 2200, 2300.

The user experience for express seller merchant websites 2300 is identical to that for a primary account 1400, except the sponsored account holder will be allowed to enroll for express seller relationships without any external funding sources 2100 (unlike primary accounts, which may be required to have a funding source).

In some implementations, restrictions can be set for any merchant. In one example, the sponsor may specify any merchant—standard, express session and/or the express seller merchants 2180, 2200, 2300, that the sponsored account may make purchases from. Alternatively, the sponsor may restrict the sponsored account from making purchases from certain standard, express session and/or express seller merchants 2180, 2200, 2300. The primary account holder may also be provided with the option to limit the merchant websites 2180, 2200, 2300 that the sponsored accounts 1500, 1590 can make purchases from to merchant websites that have express seller status.

In one example, the sponsored account may be closed in three ways: by the sponsor, by the closing of the primary account 1400, and by the sponsored account holder.

In one example, the sponsor may also use the sponsor account 1400 to close one or more sponsored accounts 1500, 1590, and to reactivate the sponsored account 1500, 1590 after closing the sponsored account 1500, 1590. After the sponsored account 1500 is closed by the sponsor account 1400, the user of the sponsored account 1500 cannot make purchases using the funds in the sponsored account balance 1530. In one example, when the sponsored account 1500, 1590 is closed all funds remaining in the account 1500, 1590 are transferred back to the primary account 1400.

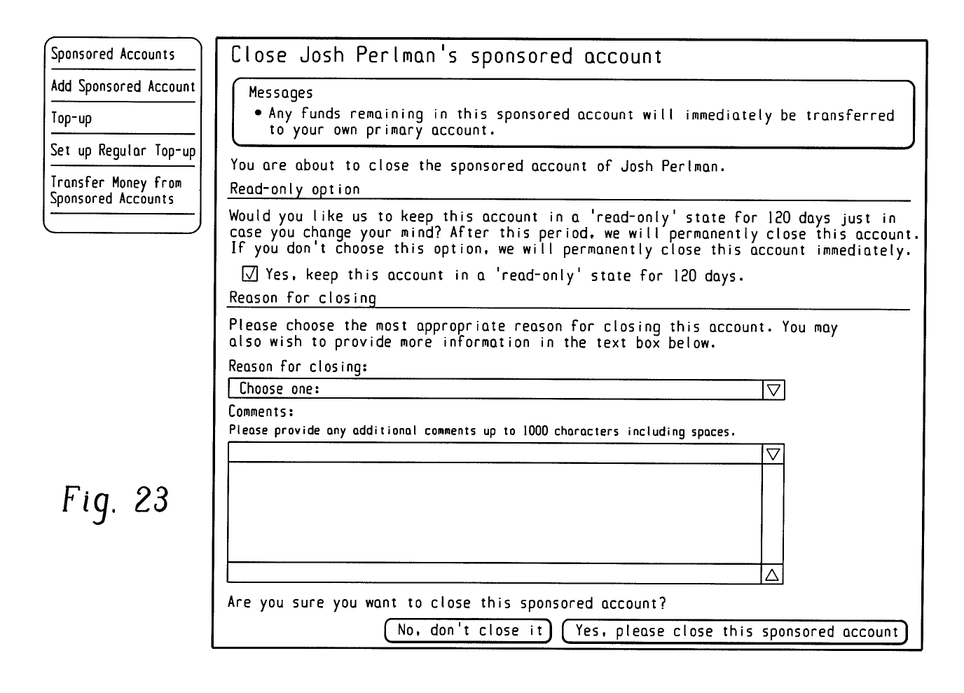

Returning to FIG. 13, which is the Sponsored Account summary page for the selected sponsored account 1500, the sponsor may click on the close account link to initiate closing the account. This link leads to an example graphical user interface page, such as that shown in FIG. 23 for closing the account. The sponsor may select to set the sponsored account 1500 to read only status. In a read only sponsored account 1500 after the sponsored account 1500 is closed by the primary account 1400, the sponsor and/or the sponsored account holder may still access certain information in the sponsored account 1500, such as transaction data 1550, for a period of time, such as 120 days. In the example page, the sponsor must select a “Reason for closing the account,” which will provide useful feedback to the system provider regarding any technical or design failures.

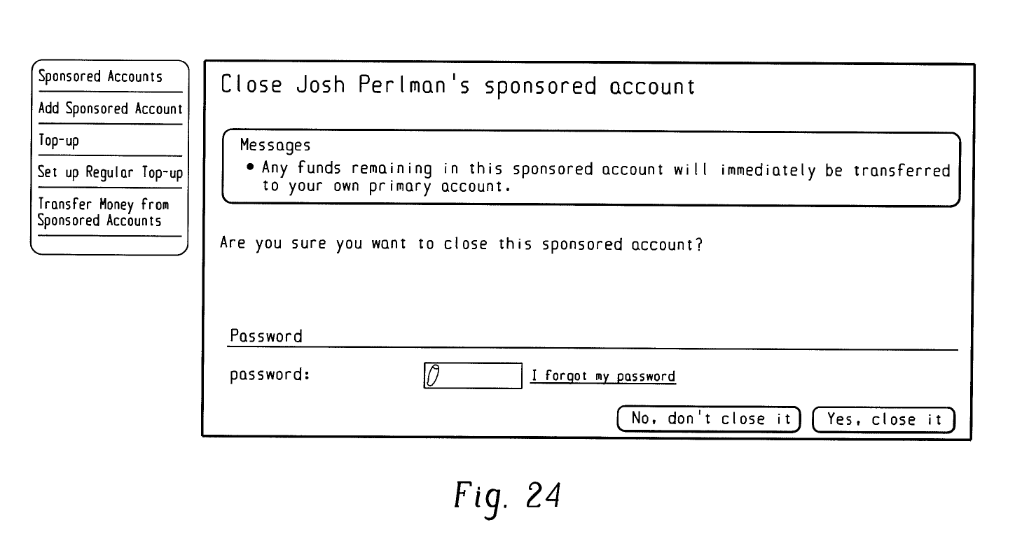

After reading the account closure rules/details, the sponsor can click on “Yes, please close this Sponsored account” or “No, don't close it.” If the sponsor selects “Yes . . . ” and enters a password for authorization, then the next screen re-informs them about account closure rules and prompts them to confirm or cancel. FIG. 24 shows an example graphical user interface for confirming the account closure. After confirmation of the account closure, the system will send an e-mail to the sponsored account holder notifying them that the sponsor has closed the sponsored account 1500. In addition, the sponsor will also receive a confirmation email that the sponsored account 1500 has been closed.

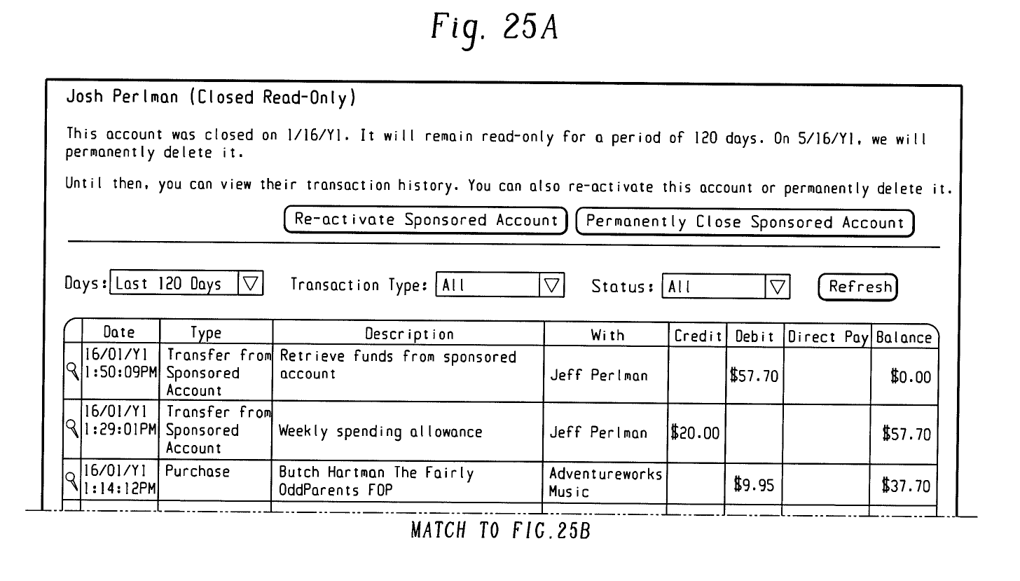

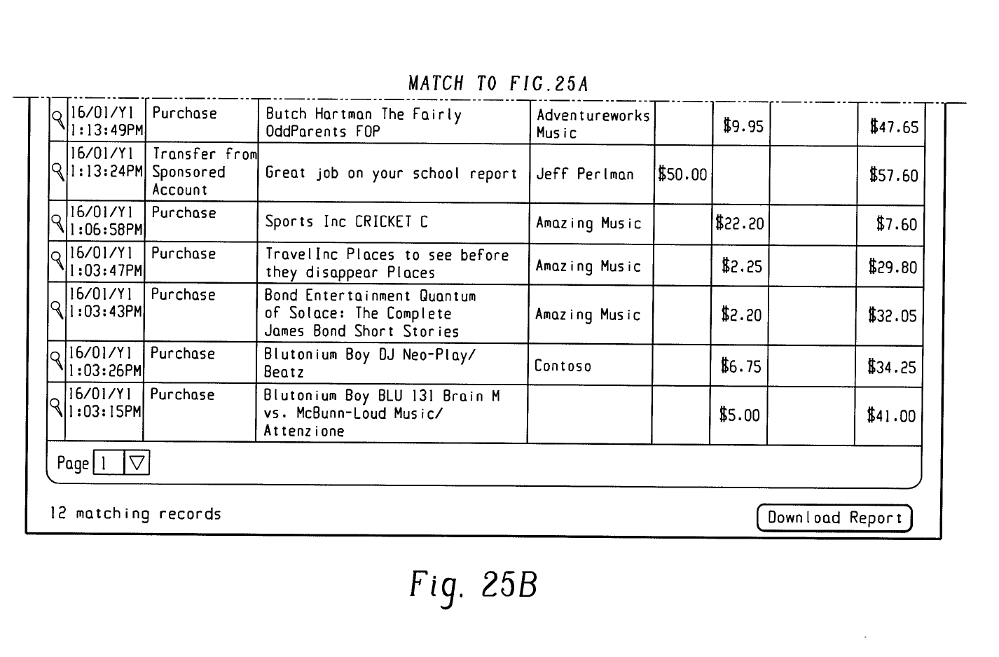

A sponsor's read-only access to a closed sponsored account 1500 also provides the sponsor with the option to re-activate the sponsored account or permanently close the sponsored account. See, for example, FIG. 25, which shows an example graphical user interface for viewing the read-only information on the sponsored account 1500 and for reactivating the account. Reactivation in one example would restore the sponsored account 1500 to active status, provide an option to re-fund the sponsored account 1500, and cause a notification e-mail to be sent to the sponsored account holder. Permanently closing the account would prevent any further user access to the sponsored account 1500.

If a sponsor closes the primary account 1400, then all sponsored accounts 1500, 1590 held within the primary account 1400 are automatically closed at the same time and all funds in the sponsored account(s) 1500, 1590 are returned to the primary account balance 1430. The primary account balance 1430 is distributed to the sponsor, for example, by a check.

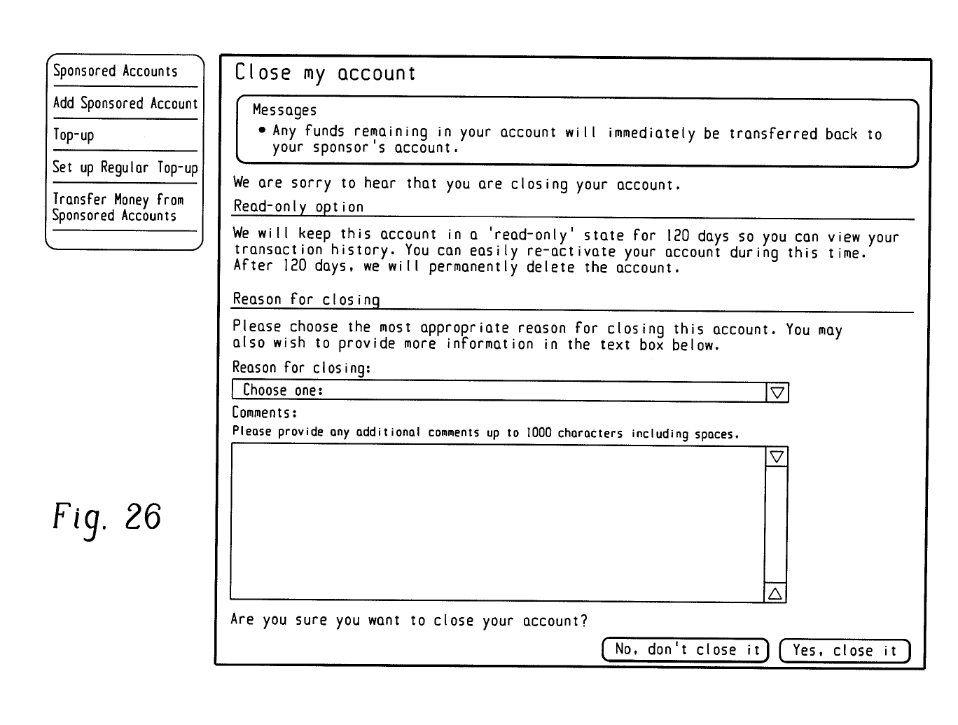

In one example, the sponsored account holder can also close the sponsored account 1500. In the example graphical user interface shown in FIG. 26, under the “Edit Profile” menu, the sponsored account holder can click on “Close Account” in the left-hand navigation menu to initiate closing the account. In one example, when a sponsored account holder closes a sponsored account 1500, it is automatically changed to “Read-only” status for a period of time, and the closed sponsored account may be accessed as described above.

In one example, the same request for a reason for closing the account, the presentation of account closure rules/details, and the request for confirmation are presented to the sponsored account holder as were presented to the sponsor as discussed above.

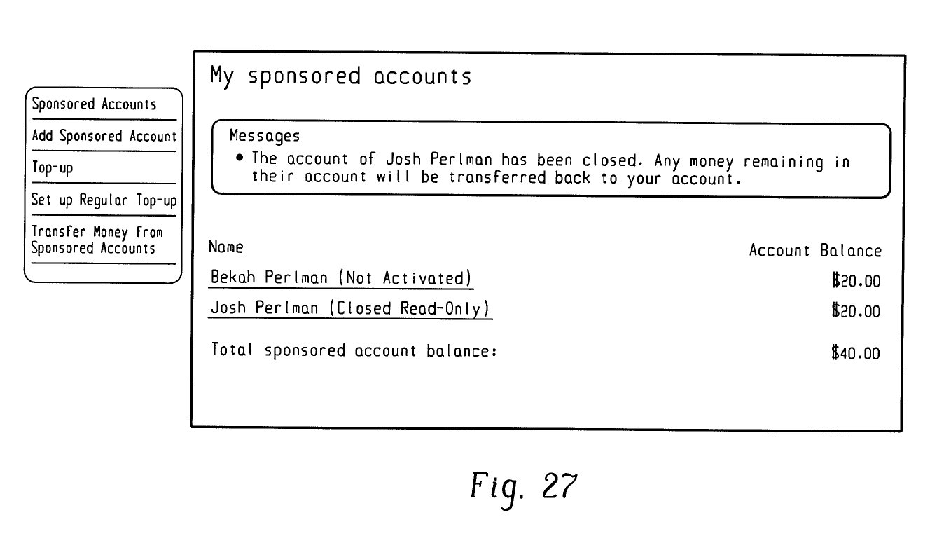

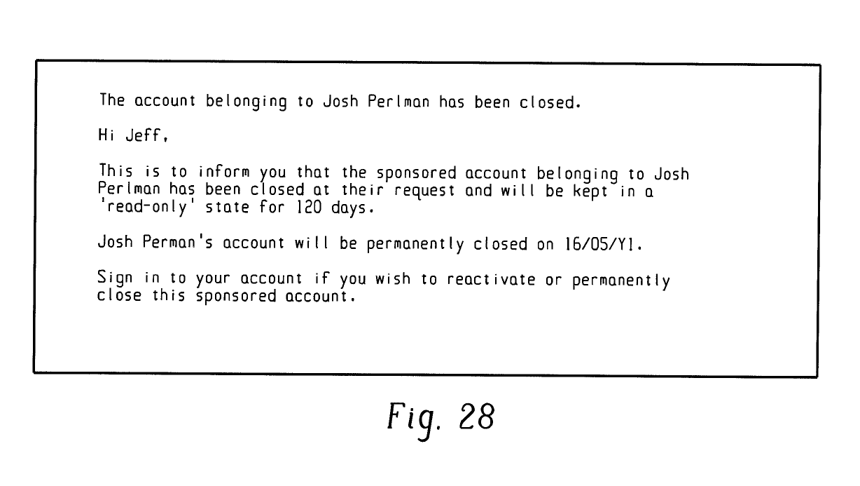

In one example, upon confirming closure of the sponsored account 1500, all recurring transfers are cancelled and any funds remaining in the sponsored account 1500 are immediately transferred to the primary account 1400. The system notifies the sponsor and/or the sponsored account holder of the sponsored account closure. For example, the system may display a message on the sponsored account summary page and/or send an e-mail (see, e.g., FIGS. 27 and 28).

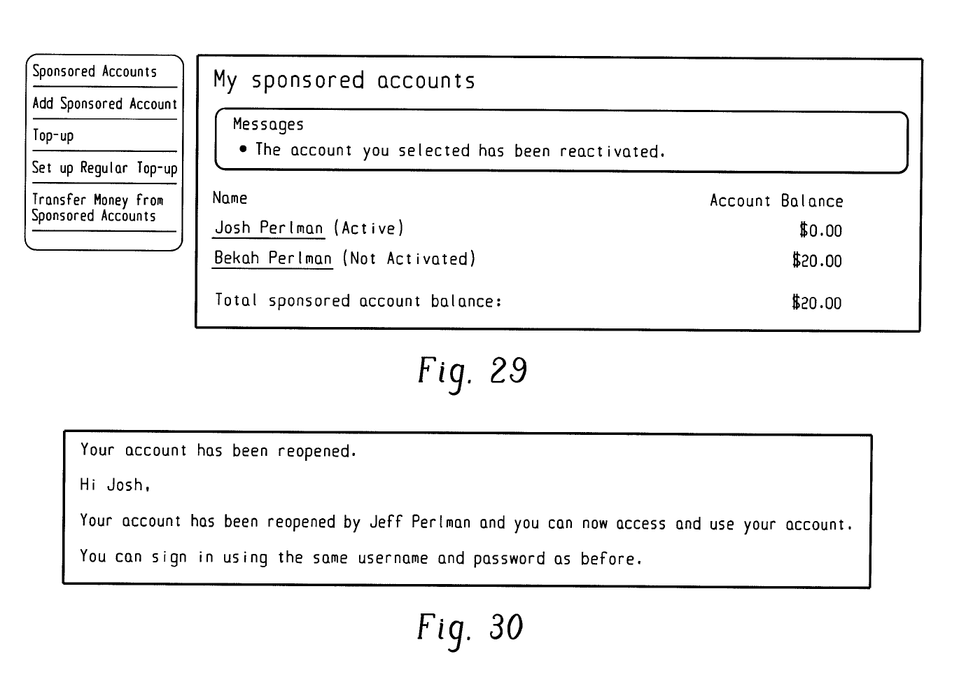

In one example, the sponsor may permanently close the sponsored account 1500 or reactivate the sponsored account 1500 as described above. However, in one example, if the account is reactivated by the sponsor, the account set up process would begin again, or in another example, a consent from the sponsored account holder would be required to reactivate the account. Another alternative embodiment allows the sponsor to reactivate the sponsored account 1500 immediately and without any consent from the sponsored account holder and presents the sponsor with a confirmation of this (see, e.g., FIG. 29). In this case, the system sends a notification, such as an e-mail to the sponsored account holder indicating that the sponsor has reactivated the account and confirming that the sponsored account holder can login with the username and password previously used (see, e.g., FIG. 30).

In one example, a sponsored account 1500, 1590 can be upgraded to a new primary user account. A sponsored account may be upgraded for a number of reasons. For example, when the sponsored account holder is a minor, the account may be upgraded to a primary account when the minor reaches the age of majority. The primary account holder may pre-authorize the upgrade based on a certain date in the future, a birth date of the sponsored account holder, or the primary account holder may authorize the upgrade for immediate effect. The system may then present the upgraded account holder with options for applying for and retaining external funding sources 2100.

In another example, the sponsor must close and delete the sponsored account before the sponsored account holder can initiate registration of a Primary Account using the same identifier, such as an email address.

FIG. 31 is a flow diagram illustrating another example method 4000 for opening a sponsored account. In step 4020, a request is made to register a new electronic payment account. The new account request may include account profile information for the applicant, including information indicating the applicant's age. Once the new account request has been submitted, an age verification is performed at step 4040 to determine the age of the applicant. If the applicant is of legal age (e.g., 18 years), then a standard account registration process proceeds at step 4060. If the applicant is not of legal age (e.g., under 18 years), then the method proceeds to step 4080.

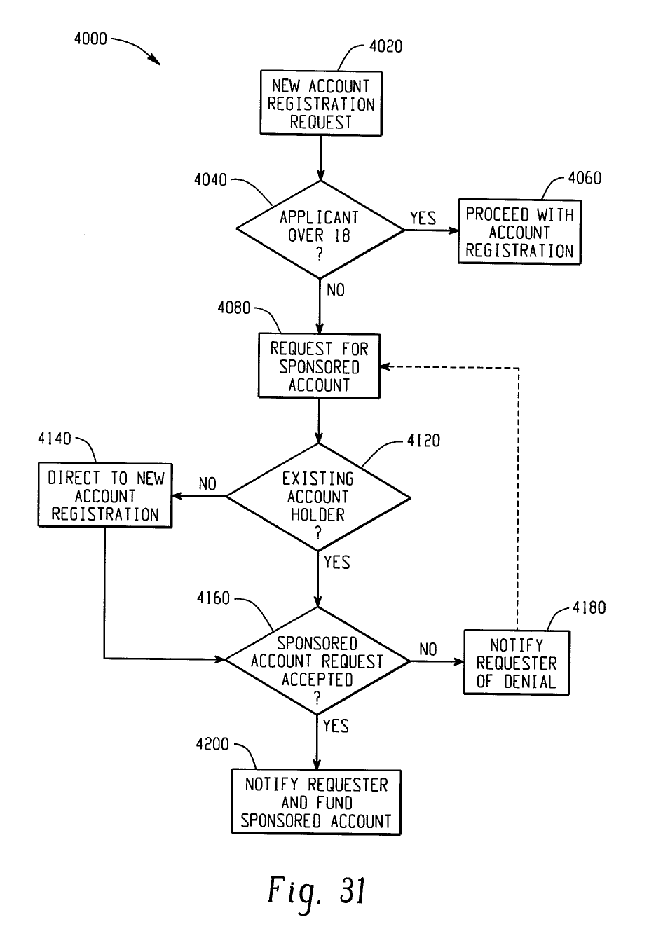

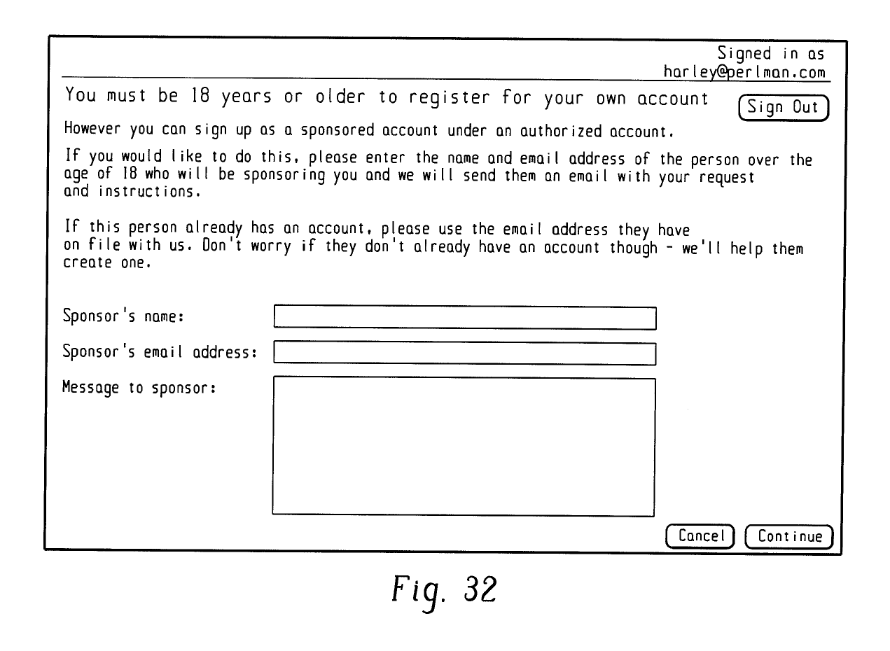

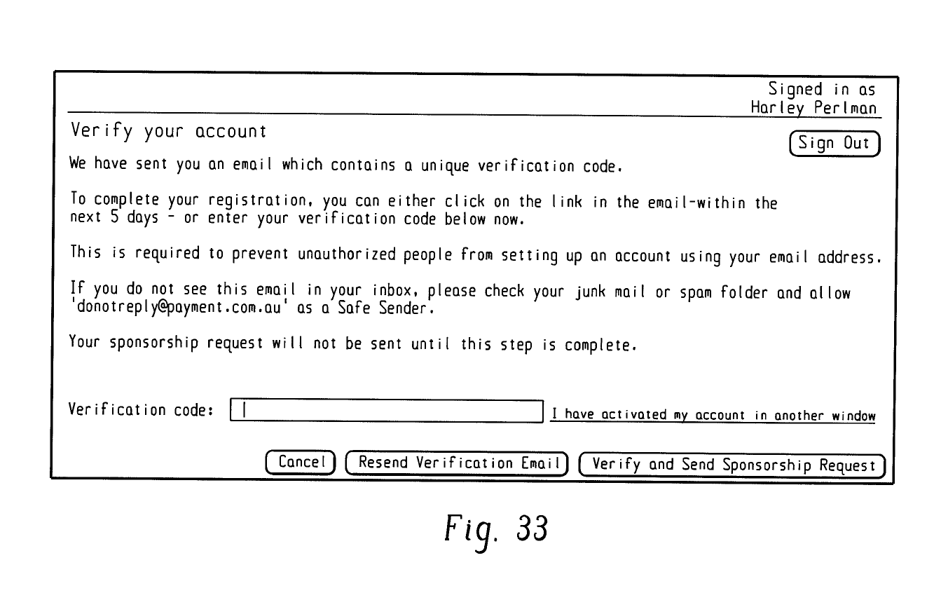

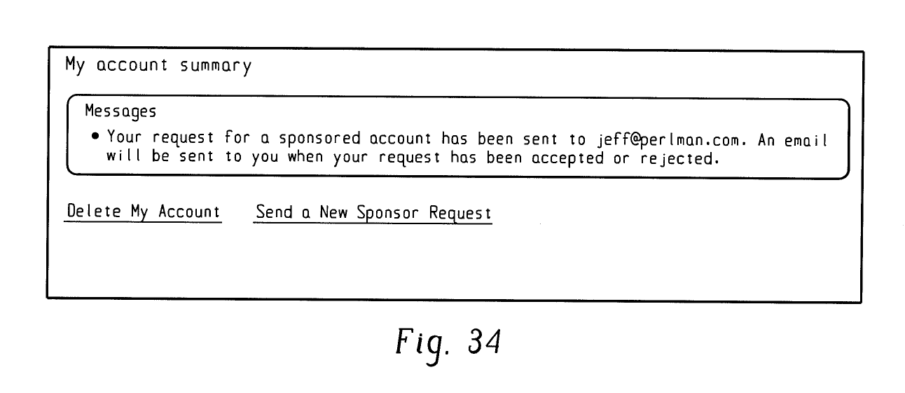

In step 4080, the underage applicant may submit a request for a sponsored account. An example user interface (e.g., web page) for requesting a sponsored account is illustrated in FIG. 32. With the user interface depicted in FIG. 32, the applicant may send a request to a potential sponsor (e.g., a person over the age of 18 such as a parent or guardian) to sponsor an account on their behalf. As illustrated, the request may be initiated by entering the potential sponsor's name, email address and a free-text message into fields provided on the user interface and then clicking on a “continue” button. In addition, the applicant may be required to verify his or her email address before the sponsored account request is transmitted. For example, a verification code may be emailed to the applicant, and the applicant may be required to enter the verification code before the sponsored account request is processed, as illustrated in FIG. 33. After the applicant has been verified and the sponsored account request has been submitted, the applicant may be linked to an account summary web page, as illustrated in FIG. 34.

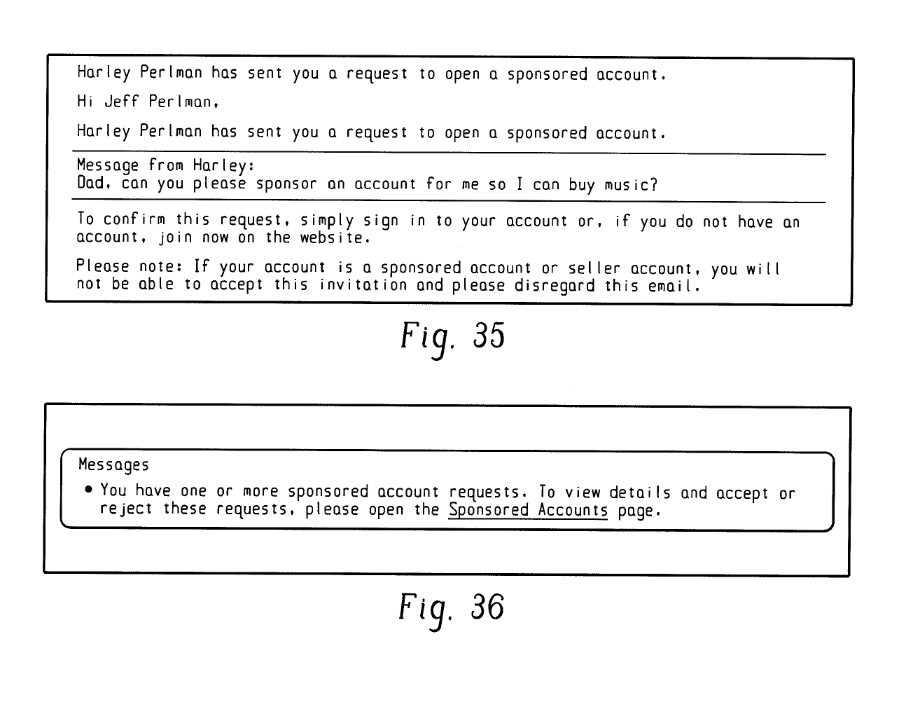

After the sponsored account request has been transmitted, the potential sponsor may receive the request via email, as shown in FIG. 35. As illustrated, the email message to the potential sponsor may include the name of the person requesting sponsorship, a message provided by the applicant, brief instructions and information about the electronic payment service. The electronic message may also indicate a restriction preventing sponsorship by other sponsored accounts or by a seller account (payee account, merchant account, etc.)

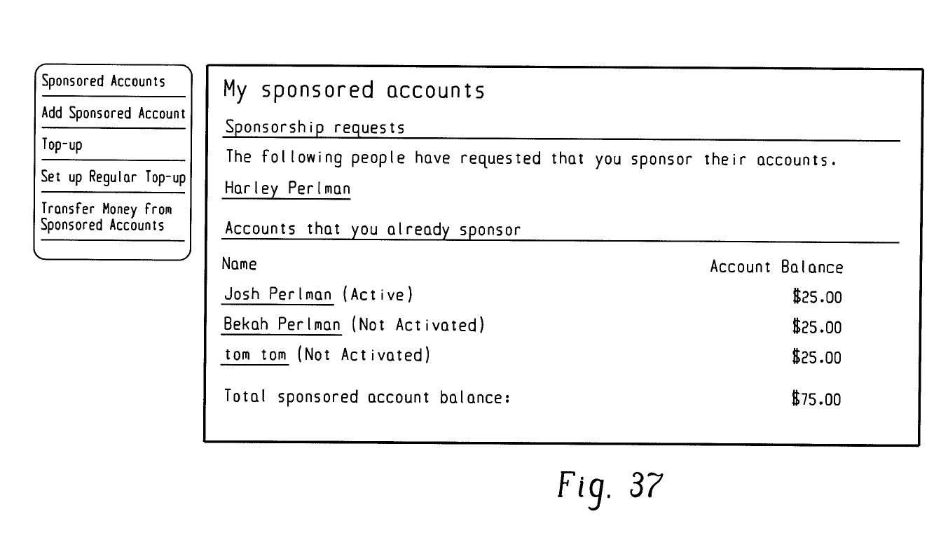

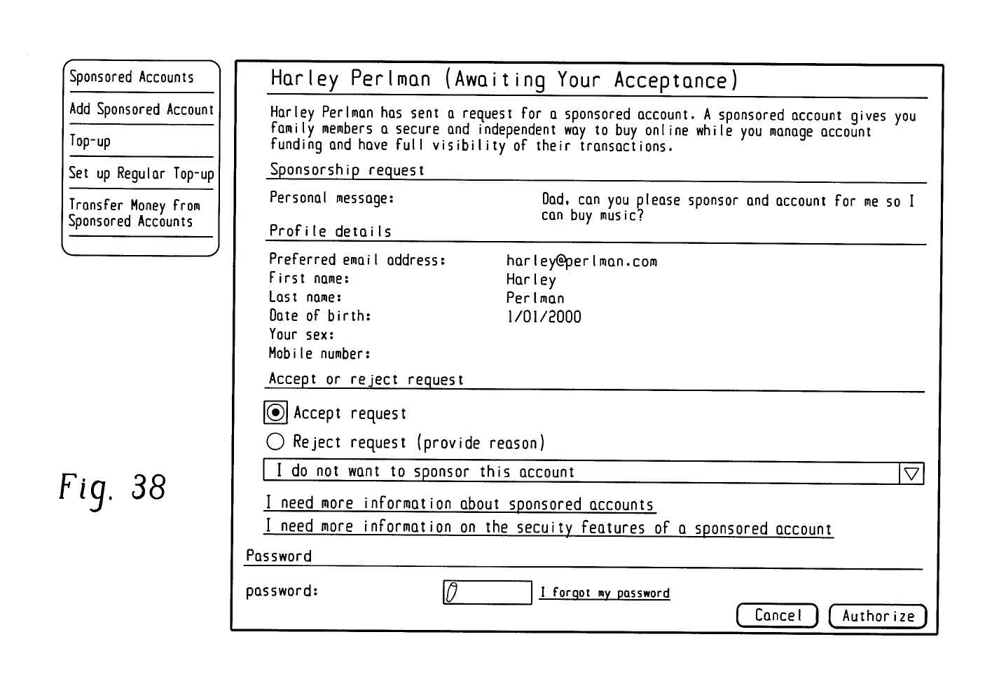

Referring again to FIG. 31, if the potential sponsor does not have an existing electronic payment account (step 4120), then he or she may be directed to a website for creating a new account (step 4140), after which they may proceed with the sponsored account (step 4160). At step 4160, the potential sponsor may accept or deny the request to sponsor an account. If the potential sponsor already has an electronic payment account, then when they sign-in to their account, a message may be provided to indicate that one or more sponsored account requests are pending, as illustrated in FIG. 36. In the example shown in FIG. 36, the potential sponsor is also provided with a link to a sponsored accounts page, an example of which is illustrated in FIG. 37. From the sponsored accounts page, the potential sponsor may select the name of the person requesting sponsorship to be linked to another page, as illustrated in FIG. 38, where they can view the message from the requestor, the profile details registered by the requestor, and choose to accept or reject the sponsorship request. In addition, the potential sponsor may also be provided with links for requesting more information about sponsored accounts or the security features of a sponsored account.

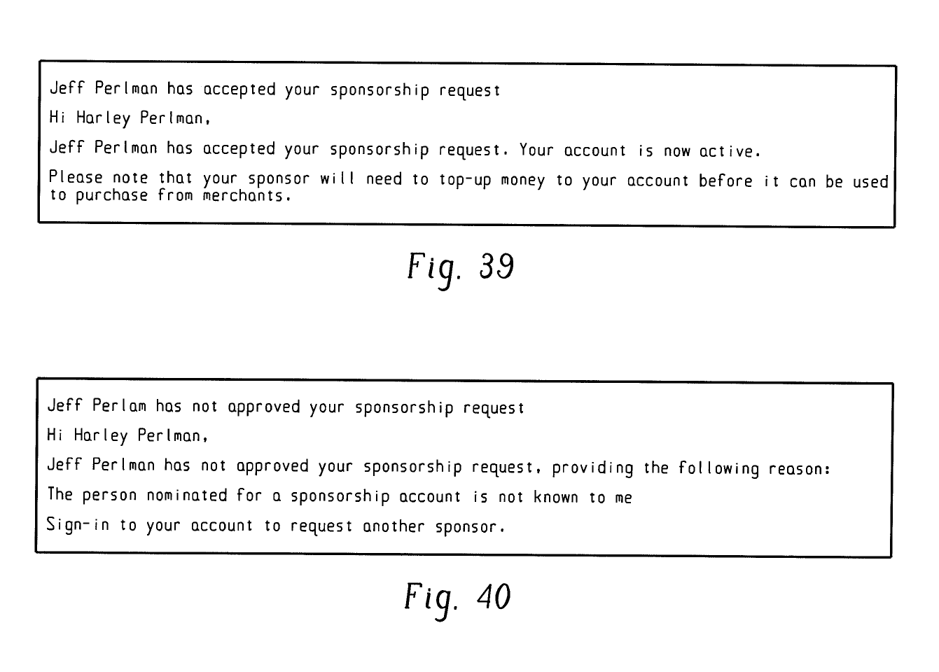

Returning to FIG. 31, upon acceptance of the request for sponsorship (step 4160), the account is activated and the sponsor can transfer funds to the sponsored account in step 4200. An email may also be sent to the new sponsored account holder to confirm that the sponsorship request has been accepted. An example notification that sponsorship has been accepted is illustrated in FIG. 39.

Referring again to FIG. 31, if the account holder rejects the requested sponsorship (step 4160), then a rejection notification is sent to the requestor at step 4180. With reference to FIG. 38, the account holder may, for example, reject the request by selecting a “reject request” radio button, selecting a reason for the rejection from a drop-down list (e.g., I do not want to sponsor this account; The person nominated for a sponsored account is not known to me; I am not the parent/guardian of the person nominated for the sponsored account), and then entering their account password and selecting the “Authorize” button. Upon rejection, the requestor may receive an email notification informing them of the rejected request and providing the stated reason, as illustrated in the example of FIG. 40.

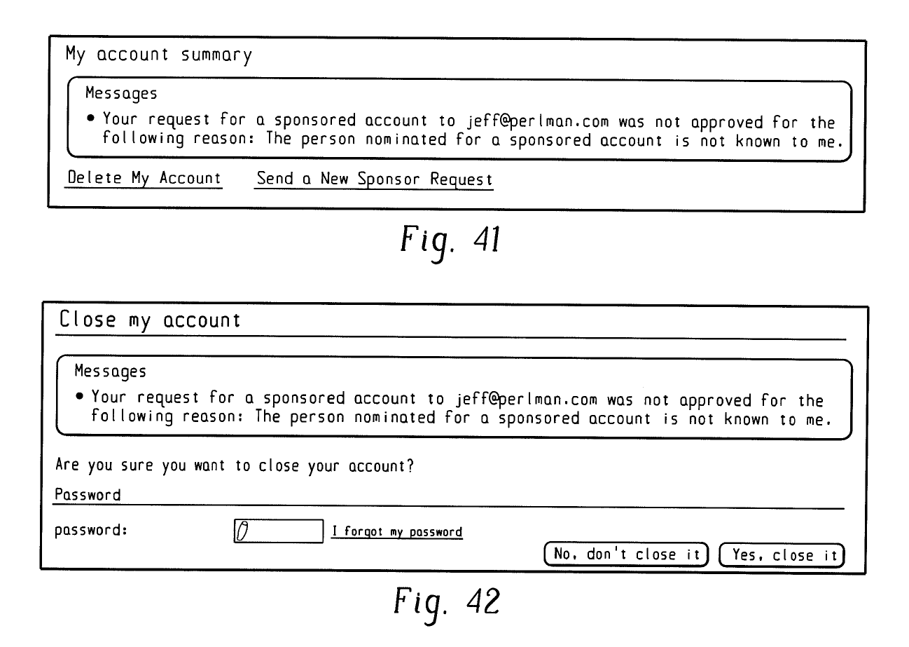

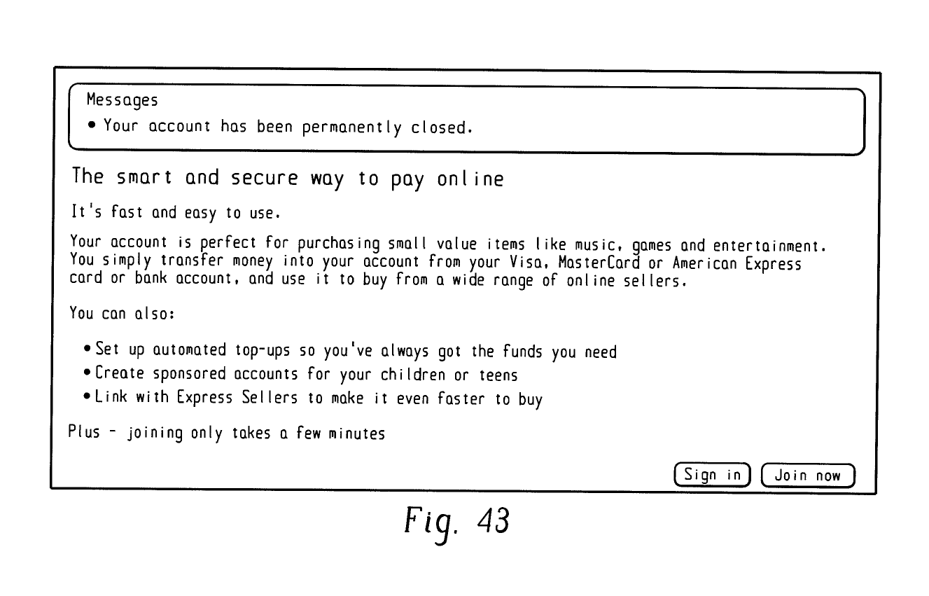

At any time during the sponsored account request process, the prospective sponsored account holder may be able to sign into their pending account, for example to check the status of a pending request, to delete the pending account, to send a new sponsorship request, or to make an electronic inquiry with the electronic payment service. When the requestor signs into his or her pending account, a message may be provided to show the status of the pending request, as illustrated in the example of FIG. 41. To delete a pending account, the user may be provided with an option to click on a “delete my account” link, as illustrated in FIG. 41, to direct the user to another page for closing the pending account, as illustrated in the example of FIG. 42. In the example illustrated in FIG. 42, the user is directed to enter their account password and then click on a “yes, close it” button to close the pending account. After closing the account, the user may, for example, be directed to a new web page that confirms that the account has been closed, as illustrated in the example shown in FIG. 43.

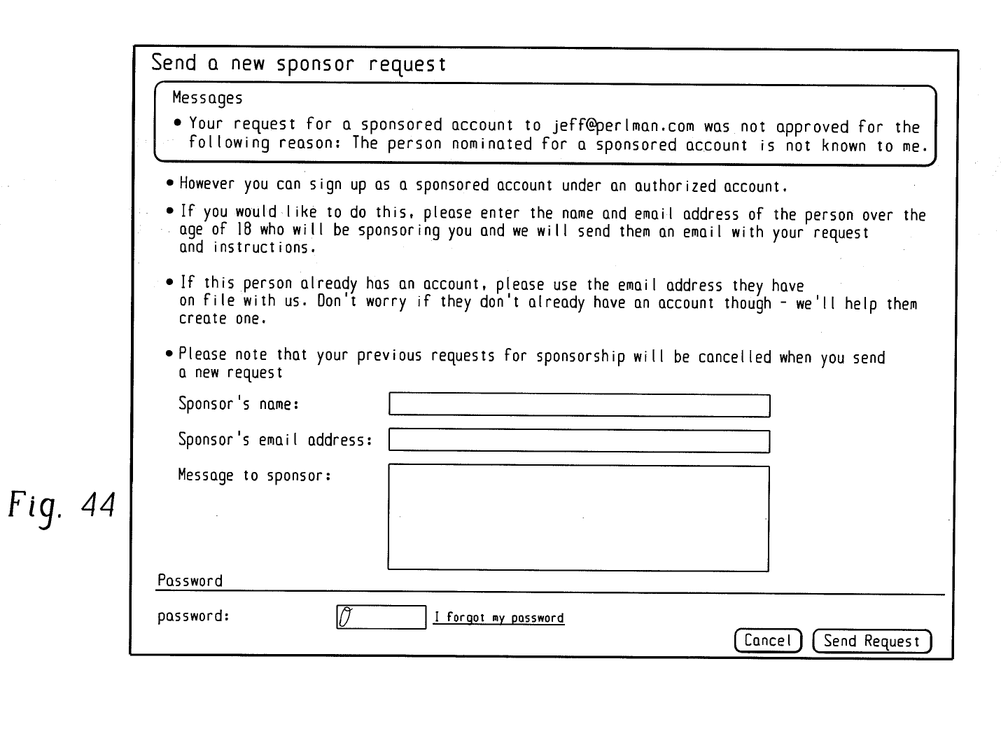

To send a new sponsor request (illustrated in FIG. 31 by the dotted line connecting steps 4180 and 4080), the user may, for example, select a “send new sponsor request” link on his or her account summary page. Requesting a new sponsor may, for example, direct the requestor to a new sponsor request page, as illustrated in the example shown in FIG. 44. Here the user may, for example, enter a new potential sponsor's name, email address and a message, and then enter a password and click on the “Send Request” button. If the applicant already has a pending request that has not yet been accepted or rejected, then these fields may be pre-populated with the details of the pending request, which may be resent or overwritten with a new request.

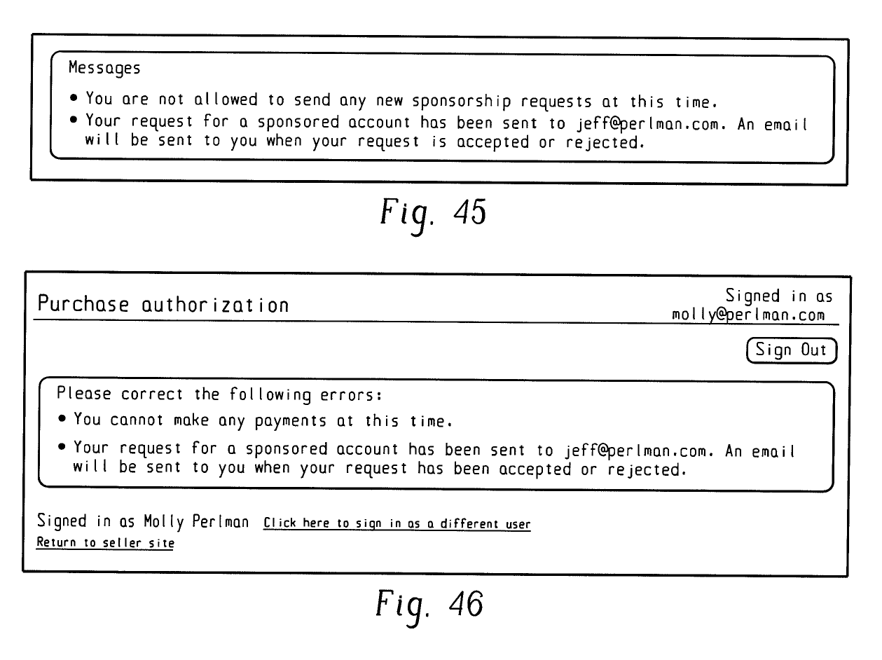

In one example, if a applicant makes more than three sponsorship requests within a set period of time (e.g., 24 hours), then the account may be temporarily suspended. For example, the user may receive a message as illustrated in FIG. 45 indicating that no new sponsorship requests may be sent at the current time. While the account is suspended, the “send new sponsor request” link may be hidden from the user and other functionality of the pending sponsored account may be disabled.

While a sponsored account request is pending, certain account functions, such as the ability to complete a transaction, are not enabled. If the user attempts to conduct a transaction before the account has been enabled, an error message may be generated, as illustrated in the example shown in FIG. 46.

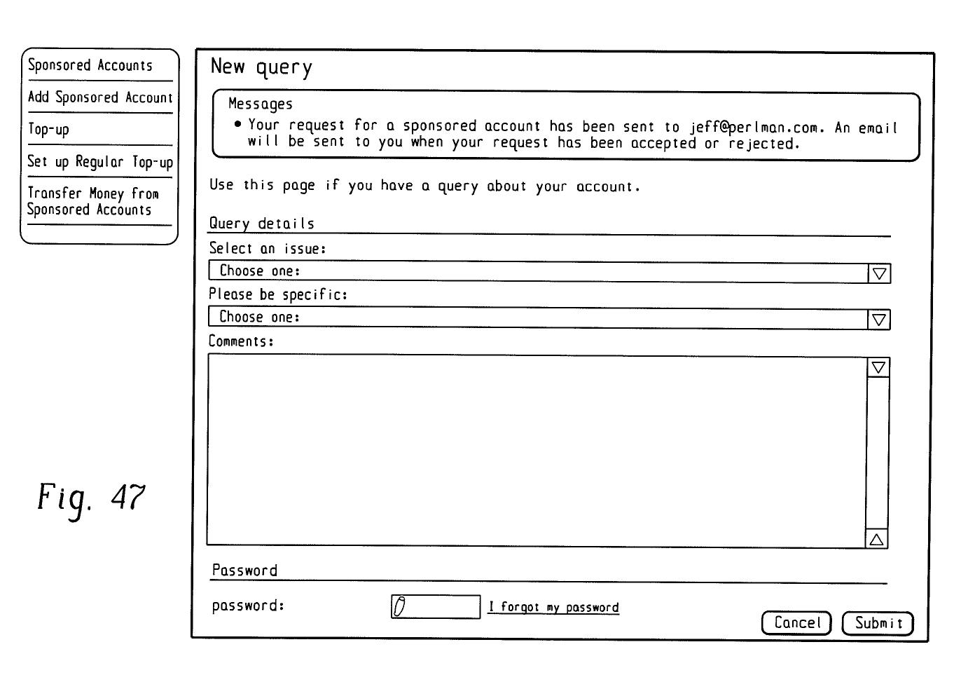

The pending sponsored account may also provide the user with the ability to enter a query to the electronic payment service, as illustrated in the example shown in FIG. 47. While the account is pending, this may, for example, be limited to general and feedback queries and the ability to view pending and closed queries.

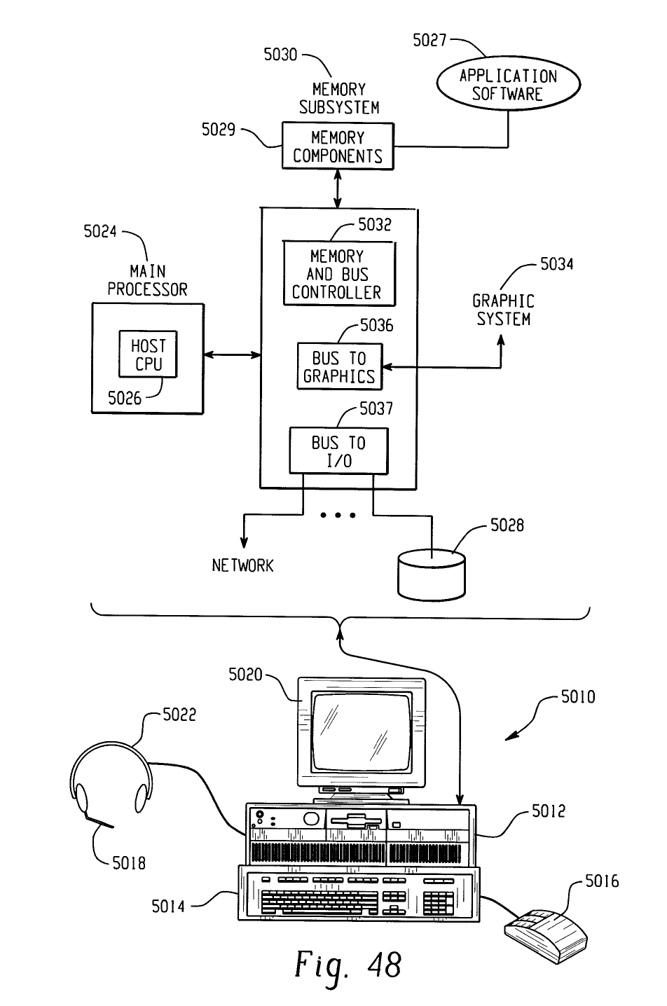

FIG. 48 illustrates exemplary hardware 5010 on which the various embodiments of the sponsored account system may be practiced. The hardware described in FIG. 48 is exemplary hardware for the user site (1050) of FIG. 5. The hardware 5010 may be a personal computer system comprised of a computer 5012 having as input devices keyboard 5014, mouse 5016, and microphone 5018. Output devices such as a monitor 5020 and speakers 5022 may also be provided. The reader will recognize that other types of input and output devices may be provided and that the present invention is not limited by the particular hardware configuration.

Residing within computer 5012 is a main processor 5024 which is comprised of a host central processing unit 5026 (CPU). Software applications 5027, such as the method of the present invention, may be loaded from, for example, disk 5028 (or other device), into main memory 5029 from which the software application 5027 may be run on the host CPU 5026. The main processor 5024 operates in conjunction with a memory subsystem 5030. The memory subsystem 5030 is comprised of the main memory 5029, which may be comprised of a number of memory components, and a memory and bus controller 5320 which operates to control access to the main memory 5029. The main memory 5029 and controller 5032 may be in communication with a graphics system 5034 through a bus 5036. Other buses may exist, such as a PCI bus 5037, which interfaces to I/O devices or storage devices, such as disk 5028 or a CDROM, or to provide network access.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer-readable medium for execution by, or to control the operation of, data processing apparatus.

The computer-readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them, A propagated signal is an artificially generated signal, e.g., a machine-generated electrical, optical, or electromagnetic signal, that is generated to encode information for transmission to suitable receiver apparatus.

A computer program (also known as a program, software, software application, script, or code), can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., on or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer-readable media suitable for storing computer program instructions and data include all forms of nonvolatile memory, media, and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) to LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any from, including acoustic, speech, or tactile input.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context or separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed o a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

What is claimed is:

1. A computer-implemented payment system, comprising:
an account processor to execute software instructions for creating and managing electronic payment accounts;
an accounts database to store account data from the account processor;
the account processor being configured to create a primary account and a sponsored account in the accounts database;
the primary account being associated with a primary account holder, the primary account holder having access to the primary account to add and remove funds; and
the sponsored account being associated with both the primary account holder and a sponsored account holder, the primary account holder having access to the sponsored account to transfer funds between the primary account and the sponsored account in order to add and remove funds from the sponsored account, the sponsored account holder having access to the sponsored account for making transactions using funds in the sponsored account.

2. The computer-implemented payment system of claim 1, wherein the sponsored account holder's access to the sponsored account is limited to transactions that have been pre-authorized.

3. The computer-implemented payment system of claim 2, wherein the pre-authorized transactions include only purchases from merchant websites that have been approved by the primary account holder.

4. The computer-implemented payment system of claim 2, wherein the pre-authorized transactions include only purchases from categories of merchants that have been approved by the primary account holder.

5. The computer-implemented payment system of claim 2, wherein the pre-authorized transactions include only purchases for amounts within a pre-approved spending limit set by the primary account holder.

6. The computer-implemented payment system of claim 2, wherein the pre-authorized transactions include only purchases from merchant websites that have been certified by the computer-implemented payment system.

7. The computer-implemented payment system of claim 1, wherein the primary account is funded from one or more external funding sources and the sponsored account is funded solely from the primary account.

8. The computer-implemented payment system of claim 1, wherein the account processor and the accounts database are included within one or more servers.

9. The computer-implemented payment system of claim 1, wherein the primary account and the sponsored account are both authenticated by an authentication broker.

10. The computer-implemented payment system of claim 1, wherein the primary account is configured by the primary account holder to automatically transfer funds to the sponsored account at pre-determined intervals.

11. A method of creating an electronic payment account, comprising:
receiving at an account processor a request to create a new electronic payment account, the request including account profile information relating to an applicant;
determining from the account profile information if the applicant is over a predetermined minimum age for opening a primary account;
if the applicant is over the predetermined minimum age, then opening a primary account for the applicant using the account profile information; and
if the applicant is not over the predetermined minimum age, then:
automatically directing the applicant to a graphical user interface for requesting a sponsored account;
receiving from the applicant via the graphical user interface information identifying a sponsor;
requesting approval for the sponsored account from the sponsor; and
upon receiving approval from the sponsor, the account processor creating a sponsored account for the applicant and linking the sponsored account to a primary account associated with the sponsor, wherein the sponsor is given access to the sponsored account to transfer funds from the primary account to the sponsored account and the applicant is given access to the sponsored account for making purchases using funds in the sponsored account.

12. The method of claim 11, further comprising:
determining if the sponsor has an existing primary account; and
upon determining that the sponsor does not have an existing primary account, directing the applicant to a graphical user interface for creating a primary account.

13. The method of claim 11, wherein the applicant's access to the sponsored account is limited to transactions that have been pre-authorized.

14. The method of claim 13, wherein the pre-authorized transactions include only purchases from merchant websites that have been approved by the sponsor.

15. The method of claim 13, wherein the pre-authorized transactions include only purchases from categories of merchants that have been approved by the sponsor.

16. The method of claim 13, wherein the pre-authorized transactions include only purchases for amounts within a pre-approved spending limit set by the sponsor.

17. The method of claim 11, further comprising:
authenticating the identity of the applicant prior to creating the sponsored account.

18. A method of processing a transaction between a secondary payer and a payee, comprising:
receiving a request for access to an item and a secondary payer identifier from the payee;
requesting and verifying the secondary payer's identity;
accessing a database to determine whether the secondary payer has an account that is associated with a primary payer;
based upon a determination that the secondary payer has an account that is associated with a primary payer, accessing the database to determine whether the request for access to the item is a transaction that is permitted by the primary payer;
based upon a determination that the request for access to the item is a transaction that is permitted by the primary payer, accessing the database to determine whether the account contains funds greater than or equal to a required value for accessing the item; and
based upon a determination that the account contains funds greater than or equal to the required value, permitting access to the item by the secondary payer.

19. The method of claim 18, wherein the primary payer is a parent or guardian and the secondary payer is a child.

20. The method of claim 18, wherein the primary payer is an employer and the secondary payer is an employee.

21. The method of claim 18, wherein permitted transactions are set by the primary payer to limit a type of transaction that may be performed by the secondary payer.

22. The method of claim 18, wherein permitted transactions are set by the primary payer to limit a dollar amount for transactions that may be performed by the secondary payer.

23. The method of claim 18, wherein the account is a sponsored account associated with both the primary payer and the secondary payer, and the sponsored account is funded from a primary account associated with the primary payer.

24. A memory for storing data for access by an account processor in an electronic payment system, comprising:
a primary account data structure stored in the memory and including information resident in an accounts database used by the account processor, the primary account including data that associates the primary account with a primary account holder to provide the primary account holder with access to the primary account to add and remove funds; and
a sponsored account data structure stored in the memory and including information resident in the accounts database used by the account processor, the sponsored account including data that associates the sponsored account with both the primary account holder and a sponsored account holder, the sponsored account data structure providing the primary account holder with access to the sponsored account to transfer funds between the primary account and the sponsored account in order to add and remove funds from the sponsored account, and the sponsored account data structure providing the sponsored account holder access to the sponsored account for making transactions using funds in the sponsored account.

25. The memory of claim 24, wherein the sponsored account data structure limits the sponsored account holder's access to the sponsored account to transactions that have been pre-authorized by the primary account holder.
